(19) United States
(12) Patent Application Publication
(10) Pub. No.: US 2020/0326687 A1
(43) Pub. Date: Oct. 15, 2020

(54) RELEVANCE BASED DIGITAL BUILDING

(71) Applicant: Michael T. MacKay, Port Saint Lucie, FL (US)

(72) Inventor: Michael T. MacKay, Port Saint Lucie, FL (US)

(21) Appl. No.: 16/909,851

(22) Filed: Jun. 23, 2020

Related U.S. Application Data
(62) Division of application No. 15/656,177, filed on Jul. 21, 2017.
(60) Provisional application No. 62/365,933, filed on Jul. 22, 2016.

(51) Int. Cl. G05B 19/4155; G06Q 50/16; G06N 5/02

(52) U.S. Cl. CPC G05B 19/4155; G06Q 50/16; G06N 20/00; G06N 5/022; G05B 2219/33002; G06N 5/02

(57) ABSTRACT

The Relevance Based Digital Building [RBDB] invention describes a method and apparatus consisting of a hardware and software environment that creates a relevance based digital building intelligence system. RBDB defines a Network Lighting System [NLS] that delivers the network fabric for an array of intelligent luminaries configured with Internet of Things [IoT] devices. Layered on the NLS network fabric is a Digital Building Intelligence information architecture that enables the building to become Self-Aware with Digital Personas. The building can manage many of its own needs through operational optimization, Machine to Machine [M2M] and machine to stakeholder interactions. RBDB allows the stakeholders associated with the building to take on a multiplicity of digital personas enabling high relevance interactions with the building and each other through these digital intelligence representations. The digital building adapts to the occupants (stakeholders) preferences and requirements and empowers he interaction between individuals (stakeholders) and their environment (Digital Building Intelligence).

### CROSS-REFERENCE TO RELATED APPLICATIONS

This application is a divisional of U.S. application Ser. No. 15/656,177, filed on Jul. 21, 2017, entitled “RELEVANCE BASED DIGITAL BUILDING” which claims priority to U.S. provisional application number 62/365,933, filed Jul. 22, 2016, which is incorporated by reference in its entirety.

### FIELD OF THE INVENTION

Significant advances have been made in information technologies especially in the areas of advanced natural language processing, information retrieval, knowledge representation, automated reasoning, deep machine learning, cognitive learning systems, digital intelligence, digital personas, Internet of Things [IoT] data acquisition, image processing, data processing, management, storage, second order logic, controlled vocabulary, Web 3.0 and big data processing. The invention defines a method and apparatus for creating a relevance-based information architecture system that advances the interactions and operations between buildings, spaces and its occupants by allowing the building to become self-aware.

### DESCRIPTION OF THE RELATED ART

Most building automation systems provide monitoring and control of major building systems: Heating, Ventilating, and Air Conditioning [HVAC], Chillers, Boilers, Elevators, Access Control, Fire, Leak Detection, and Lighting. Building automation systems advance the operational management of these building subsystems by integrating the operation of these systems with varying levels of integration.

Integrated Workplace Management System [IWMS] as a software platform integrates; Real estate management, Capital project management, Facilities management, Maintenance management, Sustainability and energy management to improve building management.

Application Programming Interfaces [APIs], Operating Systems, Real Time Operating Systems [RTOS], lexicons, semantics, Resource Description Framework [RDF], triple stores, key value storage, inference engines, semantic web, bots, micro data, second order logic, predictive systems, cognitive machine learning, digital intelligence, and digital personas are integrated in the RBDB patent.

Sensors, detectors, transducers, Micro Electrical Mechanical Systems [MEMS], micro electro optical mechanical fluidics systems, microelectronics, microcontrollers, solid state lighting, Information Technology [IT] computers, computer networking, device networking, Internet of Things [IoT], data storage, software, hardware, firmware, cameras, image sensors, multi-spectral, hyper-spectral, modulators, demodulators, multiplexors, de-multiplexors, transmitters, receivers, Radio Frequency [RF], free space optics are many of the related technologies that are utilized in the RBDB patent.

### SUMMARY OF THE INVENTION

### Overview

The invention is a system of multilayer hardware and software modules that when integrated deliver personalized profession based occupancy and interactions with digitally enabled facilities and spaces. A Network Lighting System [NLS] (0) will form the first layer that includes a Luminaire Device Network [LDN] (4) to deliver illumination, sensors and actuators under computer control. Each layer adds intrinsic value to the next layer culminating in a high level of operational and interaction intelligence. The RBDB system integrates the following subsystems and elements to deliver the relevance based digital building capabilities:
1. Network Lighting System [NLS] (0) the is comprised of Power over Ethernet [PoE] Network Switches [NWS] (1) that interconnect Intelligent Control Surfaces [ICS] (2), Lighting Control Systems [LCS] (3) and Luminaire Device Networks [LDN] (4) with each other and the computing cloud.
2. Power over Ethernet [PoE] Network Switches [NWS] (1) deliver electrical power and network computing data communication intra and inter facility. The NWS (1) provides the interconnect fabric to interoperate with Information Technology [IT] system through private and public networks.
3. Intelligent Control Surfaces [ICS] (2) provide the Computer Human Interfaces [CHI] required to design, create, deploy, configure, operate, maintain, and extend the NLS (0) and its digital intelligence additions.
4. Lighting Control Systems [LCS] (3) provide the computing environment required to deploy, configure, operate, maintain, and extend the NLS (0). The LCS (3) also manages a plurality of data feeds generated by the Luminaire Device Network [LDN] (4). The LCS (3) also communicates with LDN (4) generators, dispensers, actuators and other Building Automation Systems [BAS].
5. Luminaire Device Network [LDN] (4) consists of a luminaire that combines optics, electronics and mechanical systems to instantiate illumination, dispersions, emissions, detectors, sensors, transducers, transceivers, antennas, waveguides, computing, data storage, networking into a lighting fixture luminaire as selectable options.
6. Computing environment for processing Network Lighting Systems [NLS] (0) LDN (4) data into higher level of understanding of building status, usage and occupants' requirements and behaviors.
7. Computing environment for processing Network Lighting Systems [NLS] (0) relevance based information as required to provide adaptation of the building based on the requirements of each stakeholder and groups of stakeholders.
8. Computing environment for processing information required to generate Digital Building Intelligence [DBI].
9. Computing environment for processing information required to generate Digital Intelligence and Digital Personas for stakeholders associated with an Intelligent Digital Building
10. Computing environment for processing Network Lighting Systems [NLS] (0) enabled interactions between stakeholders in digital buildings as required to deliver goods, services and related activities.
11. Computing environment for processing information about the management and interactions between stakeholders and intelligent digital buildings in context to activities in the outside world.
12. Computing environment that processes information related to the Internet of Things Digital Intelligence and Big Data management for intra and inter network interoperability.

Together these systems allow continuous real time command control communications and intelligence about any RBDB equipped buildings to deliver a multiplicity of advanced activities and best practices related to the roles and responsibilities of each building and its stakeholders. This provides the ability to generate digital personas for people and inanimate objects (building and its constituent parts) that empower high relevance interactions, activities and evolutions.

### Solid State Lighting

Whereas a typical lighting fixture would be wired into a building electrical infrastructure to provide illumination it traditionally exhibited a limited set of features and functions:
On Off Switching
Dimming Control
Occupancy Sensors

Solid State Lighting Light Emitting Diodes [LED]s have made significant advancements in brightness, color temperature, energy efficiency, and cost effectiveness. This conversion is big business as the operational energy savings is significant. This process is being disrupted by a new approach to this conversion.

The LED retrofit bulb market requires a power supply to be embedded into each LED light bulb since LEDs are diodes and require DC Direct Current to operate. All lighting in commercial and residential building is built on a 117 Volt or higher voltage AC Alternating Current. These power supplies are inefficient and generate unnecessary cost and waste heat. This is about to change as we have two significant factors driving the acceleration of a new LED lighting system the DC Pulse Modulation LED Lighting System! The Pulse Width Modulation PWM System significantly reduces the amount of electrical energy required to generate a Lumen of light. Standard incandescent light bulbs consume 15 W per lumen compared with 200-300 lumens per watt for LED. A 100 W incandescent light bulb generates 1500 lumens. A LED bulb can generate 1500 lumens with 7.5 W.

The first factor is that with this operational efficiency of 300 Lumens per watt we are now able to power the lighting fixture with less than 7.5 W by taking advantage of phosphor persistence and capacitive reactance in the wiring and pulsing the DC power instead of leaving it on all the time.

This leads to the two significant factors that we mentioned. Now we do not require high voltage AC wiring to any light fixture. This eliminates the building code requirement of having a licensed electrician wire all lighting fixtures with expensive 14-12 AWG Romex wire.

Now the power consumption is so low that we can power these LED luminaries from the DC power available in a PoE Power over Ethernet networking switch. Now all LED luminaries are IoT smart lights that not only connect to the Ethernet switch for power but also now are connected to the network for bidirectional data communications to the Luminaries.

This power and data connectivity allows for computer control of every light over low voltage low cost 24 AWG CAT5e networking cable infrastructures. Now the lights are not connected to the electrical infrastructure of the building they are connected to the computing network.

This defines a global transition to Solid State Lighting that provides the illumination platform to create a Network Lighting System [NLS] (0) that leverages the Luminaire Device Network [LDN] (4) to create intelligent relevant interoperability between stakeholders and buildings.

### Digital Building Intelligence

The RBDB invention creates an array fabric network of senses based on the technological equivalent of the human senses. Human sight is augmented with electronic imaging systems, hearing is augmented with vibration sensors, taste and smell are augmented with chemical and biological sensors, touch is augmented gesture systems, and together they extend the human sensory experience beyond our natural capabilities.

The RBDB invention has selected lighting fixtures/luminaires as the platform to deploy the sensor and actuator systems because lighting is ubiquitous in places occupied by humans. Building architectures and infrastructure planning has lighting everywhere a human is expected to occupy, work or visit. This creates the perfect platform to get the degree of sensor and actuator coverage required to raise the intelligence of the building.

The RBDB invention has identified that in order to make use of the large sets of data that will be generated by the NLS (0) that additional levels of intelligence must be associated with the raw sensor essence data. This invention has defined a multi layered approach to managing the data so that is can transition in the following sequence; data, information, knowledge wisdom.

The RBDB invention defines a series of software modules that work together to create two separate intelligence systems that interoperate with each other. One intelligence system is Building's Intelligence (39) that defines a multiplicity of functional elements interconnected with the NLS (0) to bring digital intelligence to the building. This process allows the building to take on Digital Personas, become self-aware and perform many functions that it requires for itself.

The other intelligence system is Stakeholders Intelligence (72) that defines Digital Personas for individuals that have a relationship with the building. The Digital Personas allow other stakeholders and the Building to understand what role a particular individual is presenting at any point in time. This allows the Building and other Stakeholders the ability to understand what is relevant to the Building and or Stakeholder at this point in time.

The Buildings' Digital Intelligence in the RBDB is created by defining a building controlled vocabulary. The controlled vocabulary starts with a natural language Lexicon (49) that requires controlled vocabulary word usage and Synsets to be defined. This controlled vocabulary is used to define a buildings' systems ontology (48). The ontology organizes all the information the building will require to function by adding semantic Meta and micro data (47) to structure unstructured data. The buildings' structured data empowers a semantic reasoner (44) that can reference other systems on the buildings' Software Bus (75) to infer what the building should do to affect its best practices to the buildings' digital intelligence (39).

The sequence is repeated for the stakeholders of the building allowing high relevance best practices to become the next generation operational and interaction standard.

### DESCRIPTION OF THE FIGURES

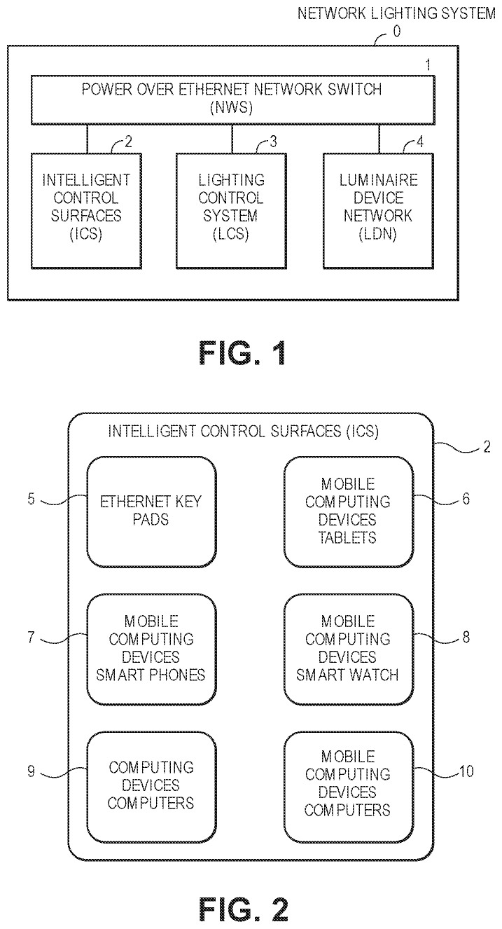

### FIG. 1 Network Lighting System [NLS]

FIG. 1 Network Lighting System [NLS] (0) defines a solid state lighting system that is comprised of the following systems:

1 [NWS] Power over Ethernet [PoE] Network Switches

The Network Switches [NWS] (1) is the computer network interconnects that routes data packets to and from nodes on a computer network. These industry standard devices have been enhanced to include electrical power so that devices connected to the computing networks can be powered from the network connections used for data exchange.

### 2 [ICS] Intelligent Control Surfaces

Intelligent Control Surfaces [ICS] (2) are a multiplicity of devices that are capable of connecting to the Network Switches [NWS] (1). The ICS (2) send and receive data packets through the NWS (1) that is also connected to the Lighting Control System [LCS] (3).

### 3 [LCS] Lighting Control Systems

The Lighting Control System [LCS] (3) provides the ability to configure and manage a specific instance of one or more NLSs. The LCS (3) accepts commands from the ICSs (2) and returns information as required operating the system. The LCS (3) communicates with the Luminaire Device Network [LDN] (4) to command, control and communicate with the modules that make up any specific intelligent luminaire LDN (4).

### 4 [LDN] Luminaire Device Networks

The [LDN] Luminaire Device Networks (4) are lighting fixtures (Luminaires) that have a multiplicity of modules that enhance the luminaires basic illumination function. The LDN (4) is an on luminaire network of modules that enhance the basic solid state lighting capabilities.

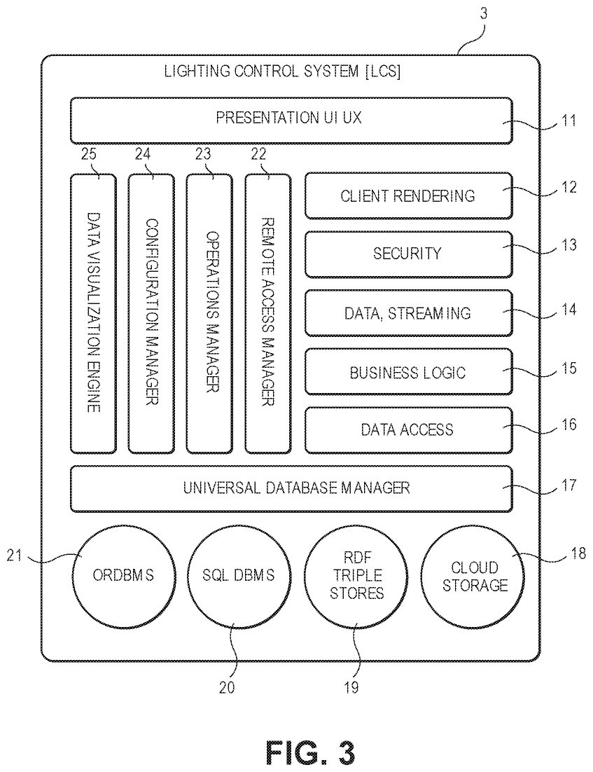

### FIG. 2 NLS Intelligent Control Surfaces [ICS]

FIG. 2 Network Lighting System [NLS] Intelligent Control Surfaces [ICS] (2) defines a multiplicity of control surfaces that will provide the Computer Human Interface between the Lighting Control Systems [LCS] (3) and the users.

### 5 Ethernet Keypads

Ethernet Keypads are electronic devices that connect to the NLS (0) network over Ethernet. Ethernet keypads include contact closures (switches) and indicators (lights and or displays) that provide one type of a user interface to the NLS (0). Ethernet keypads are manufactured in a variety of configurations and styles that would serve this function. Software would interpret the contact closures and touch screen displays to program and operate the NLS (0).

### 6 Mobile Computing Devices [MCD] Tablets

Mobile Computing Devices [MCD] Tablets are electronic devices that may connect to the NLS (0) network over wireless connections (3G, 4G, 5G, Wi-Fi). The tablet has onboard computer with a high resolution color multi-touch display that provides another option for an Intelligent Control Surface [ICS] (2). Software on the tablet communicates over public and or private networks to the LCS (3) to program and operate the NLS (0).

### 7 Mobile Computing Devices [MCD] Smartphones

Mobile Computing Devices [MCD] Smartphones are electronic devices that may connect to the NLS (0) network over wireless connections (3G, 4G, 5G, Wi-Fi). The Smartphone has onboard computer with a high resolution color multi-touch display that provides another option for an Intelligent Control Surface [ICS] (2). Software on the Smartphone communicates over public and or private networks to the LCS (3) to program and operate the NLS (0).

### 8 Mobile Computing Devices [MCD] Smart Watches

Mobile Computing Devices [MCD] Smart Watches or wearables are electronic devices that may connect to the NLS (0) network over wireless connections (3G, 4G, 5G, Wi-Fi). The wearables, Smart Watch have onboard computers with a high resolution color multi-touch displays that provides other options for an Intelligent Control Surface [ICS] (2). Software on the wearables communicates over public and or private networks to the LCS (3) to program and operate the NLS (0).

### 9 Computing Devices

Computing Devices are electronic devices that may connect to the NLS (0) network over wired Universal Serial Bus [USB], Network connections (Ethernet) wireless connections (3G, 4G, 5G, Wi-Fi). The computers provide other options for an Intelligent Control Surface [ICS] (2). Software on the computers communicates over public and or private networks to the LCS (3) to program and operate the NLS (0).

### 10 Mobile Computing Devices [MCD] Mobile Computers

Mobile Computing Devices [MCD] Mobile computers (note book, net book, laptop and related computers are electronic devices that may connect to the NLS (0) network over wired Universal Serial Bus [USB], Network connections (Ethernet) wireless connections (3G, 4G, 5G, Wi-Fi). The computers provide other options for an Intelligent Control Surface [ICS] (2). Software on the computers communicates over public and or private networks to the LCS (3) to program and operate the NLS (0).

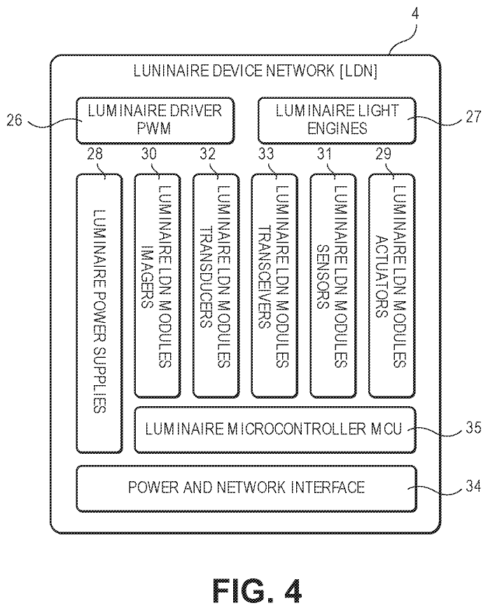

### FIG. 3 NLS Lighting Control System [LCS]

The Lighting Control System [LCS] (3) is based on industry standard computers with a compliment of custom software modules that deliver the required capability. The hardware is an industry standard personal computer [PC] that may require a plurality of PCs to manage a specific number of Intelligent Control Surfaces [ICS] (2) and intelligent Luminaire Device Networks [LDN] (4) luminaires.

The invention defines a method and apparatus in creating the information architecture and related software modules required to create a LCS (3) that not only manages the lighting but provides the configuration, command, control, communications and intelligence with the LDN (4) modules.

Additional hardware and software may be added to the NLS (0) and or the LCS (3) to process the raw essence data from the LDN (4) modules to turn the data into decision support. Adding higher level of understanding at each tier allows data to become information and the information to become knowledge and the knowledge to become wisdom. This is referred to as Data, Information, Knowledge, Wisdom [DIKW]. Data can represent facts, signals and symbols and therefore require; multifactor authentication, multifactor confirmation, text analytics, Digital Signal Processing [DSP], Digital Image Processing [DIP], contextualization, interpretation, and other levels of processing to achieve the relevance and usefulness defined in a DIKW escalation.

### 11 Presentation UI UX

The LCS (3) communication and message structure will be based on a Service Oriented Architecture [SOA] deployed as an n tier client/server computing model. This Domain Driven Design will include the business domains required to deliver the relevant information. This will be presented to the user in this presentation layer of the n tier client/server model. The presentation layer will include the User Interfaces [UI] for each of the modes of operation of the LCS (3). Together this will define the User eXperience [UX] in using the LCS (3).

### 12 Client Rendering

The presentation layer in the client/server implementation of the LCS (3) software application may be used on a variety of Intelligent Control Surfaces [ICS] (2). Each of the ICS (2) specific devices have a number of parameters that affect the user experience UX and are addressed through client rendering. Client rendering handles all the target devise requirements to deliver a successful interaction with the LCS (3) users.

### 13 Security

Security covers a wide range of data security issues required to design, construct, deploy, operate and maintain the LCS (3). Security software will handle Identity Based Security authentication, authorization, rights and privileges for each user. Data security may include:

| | |
|---|---|
| Data Copy Protection | Privacy engineering |
| Data erasure | Secure USB drive |
| Data masking | Security Breach Notification Laws |
| Data recovery | Single sign-on |
| Digital inheritance | Smart card |
| Data Encryption | Trusted Computing Group |
| Pre-boot authentication | Obfuscation |

### 14 Data & Streaming

The LCS (3) is a point of coordination for many of the NLS (0) components. Because the LCS (3) will be handling data from the Luminaire Device Network [LDN] (4) there is a significant amount of data that each LDN (4) intelligent luminaire can generate. Each LDN (4) nodes data is added to the data generated in the ICS (2) nodes and the LCS (3) data sets it generates. Combined these data sets need to be managed for real time analytics in addition to being stored and forwarded to the appropriate nodes internal and external to the NLS (0). This software module in the LCS (3) manages the data sets and data streams so they will be preserved and communicated properly to other modules in the LCS (3) and other nodes internal and external to the NLS (0).

### 14 Data Streaming

A multiplicity of data sources may require streaming data for real time data feeds. This may include video imagery, audio, vibrations, and related sensor data that informs the Digital Building Intelligence (39) and users of the Relevance Based Digital Building.

### 15 Business Logic

Domain logic or business logic is part of the LCS (3) software that deals with the business rules that control how data is created, displayed, stored, and changed. It is used in concert with other layers to define the operational capabilities of the LCS (3).

### 16 Data Access Layer

The data access layer manages the data repository connectivity allowing persistence of objects and data that will be managed in the LCS (3). Since the LCS (3) has advanced meta and micro data capabilities required to create digital intelligence the data layer must deal with Resource Description Framework [RDF] allowing the structuring of internal and external www resources for LCS (3) operation.

### 17 Universal Database Manager

The LCS (3) software stack will create a universal database manager to coherently manage a multiplicity of database repositories. Each type of repository has advantages for specific schemas, and data types. The LCS (3) software environment will be interoperating with unstructured and structured data and the database management systems that reflect each specific implementation. The LCS (3) universal database manager will deliver a common software interface across all data base management systems.

### 18 Cloud Storage

Cloud storage represents all external data repositories that the LCS (3) may require for creating, configuration, operation, maintenance and enhancement of the LCS (3). External data repositories may include external data feeds or information access, disaster recovery data volumes and other related uses as required by the LCS (3) and clusters of LCSs (3). Cloud Storage may be private clouds and or public cloud storage services.

### 19 Resource Description Framework [RDF] Triplestores

Similar to a relational database, one stores information in a triplestore and retrieves it via a query language. Dissimilar to an object relational database or a relational database, a triplestore is optimized for the storage and retrieval of triples. In addition to queries, triples can usually be imported/exported using Resource Description Framework [RDF] and other formats. A triplestore or RDF store is a purpose-built database for the storage and retrieval of triples through semantic queries. A triple is a data entity composed of subject-predicate-object.

### 20 Data Base Management System [DBMS]

Database management system [DBMS] is a collection of software applications that interacts with the user, other applications, and the database itself to capture and analyze data. A general-purpose DBMS is designed to allow the definition, creation, querying, update, and administration of databases. The LCS DBMSs may include MySQL, PostgreSQL, Microsoft SQL Server, Oracle, Sybase, SAP HANA, and IBM DB2.

### 21 Object Relational Database Management System [ORDBMS]

An Object Relational Database [ORD], or Object Relational Database Management System [ORDBMS], is a Data Base Management System [DBMS] similar to a relational database, but with an object-oriented database model. Software objects, classes and inheritance are directly supported in database schemas and in the query language. In addition, just as with pure relational systems, it supports extension of the data model with custom data-types and methods. The LCS (3) may require ORDMS to provide the data management required.

### 22 Remote Access Manager

The LCS (3) will provide on and off site remote access. Specific users will have a multiplicity of needs that shall be addressed through the remote access manager Each type of user; programmer, system administrator, maintenance engineer, user and the like will need to be authenticated and authorized through the Security manager to access the LCS (3). The remote access manager will deliver this remote access capability to the multiplicity of users.

### 23 Operations Manager

The LCS (3) Operating Manager is the software module that will communicate the operational information required to interpret ICS (2) instructions into actions defining LDN (4) operations. All operational data flow will be handled by the LCS (3) Operations Manager software module.

Operations may be as simple as turning on a light to having the lighting of the entire complex adapt to the internal and external factors in real time. This operational capability is further enhanced by the LDN (4) module complement in a building, facility or complex by the wide range of parameters and values that can be acquired or commanded from the LCS (3). Operations Manager (23) controls all aspects of the ICS (2) and the LDN (4) including command, control, communications, intelligence, data acquisition, processing and interoperability with other internal and external systems to the NLS (0).

### 24 Configuration Manager

The LCS (3) Configuration Manager is the software module that will provide the ability for the LCS (3) to custom configure a NLS (0) for a specific building or complex. The LCS (3) Configuration Manager (24) will have the ability to define and or identify the complement of LDN (4) modules that may be installed on an intelligent luminaire.

The LCS (3) Configuration Manager (24) will have the ability to define the parameters and values required to configure the array of LDN (4) intelligent luminaires. The LCS (3) Configuration Manager (24) will have the ability to define the recommended placement of the LDN (4) intelligent luminaires in a particular building, facility or complex. The LDN (4) intelligent luminaires will have a multiplicity of factors defining what complement of LDN (4) modules are on which intelligent luminaire and which location or spacing is required and or desired.

Some of the LDN (4) modules and placement factors may be driven by Occupational Safety & Health Administration [OSHA], National Fire Protection Association [NFPA], local Fire Departments, local Police Departments, local building codes and related compliance requirements.

The LCS (3) Configuration Manager (24) will have the ability to will ingest as built architectural drawings and allows the physical layout of the NLS (0) to be defined. The LCS (3) Configuration Manager will assign specific ICS (2), LCS (3) and LDN (4) nodes in the NLS (0) system and communicate the details to the LCS (3) Operations Manager (23) through the Universal Data Base Manager (17).

### 25 Data Visualization Engine

The Data Visualization Engine is used to present data sets as graphs, graphics, images, pictures, 3D models and visual data sets. These software engines are configured to accept data sets and streams and overlay information on them render the visual information and preprocess all data that may need to be visualized.

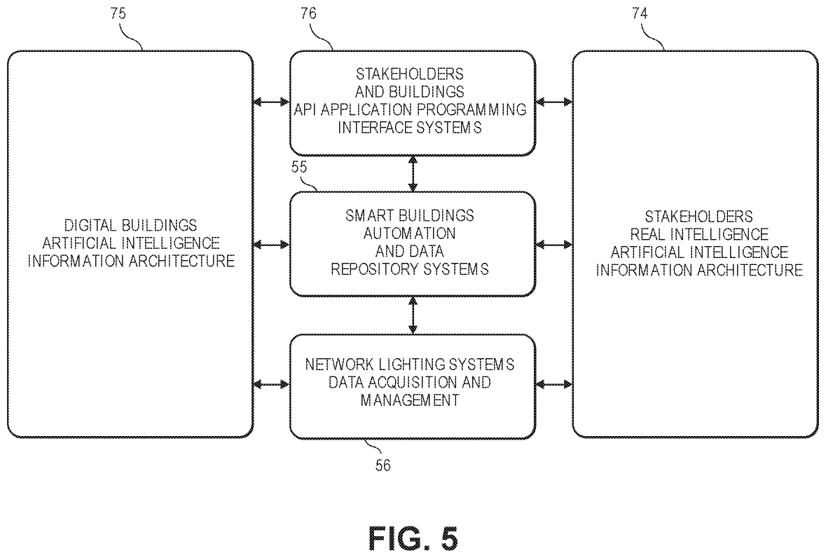

### FIG. 4 NLS Luminaire Device Network [LDN]

### 26 Luminaire PWM Driver

The Luminaire Device Network [LDN] (4) refers to a multiplicity of modules that are configured to create a specific set or individual instance of an intelligent luminaire (Lighting Fixture). Solid State Lighting [SSL] uses Light Emitting Diodes [LED]s and Laser Diodes in plurality to configure variety of SSL Luminaire Light Engines (27). These SSL Luminaire Light Engines (27) require power supplies that control Direct Current [DC] and voltage levels to properly drive them. Properly driven Luminaire Light Engines (27) will optimize desired radiant flux output, color temperature and power consumption.

Pulse Width Modulators can be added to a LDN (4) to regulate the wave shape, period and duty cycle of the DC power as a sequence of DC pulses. These DC pulses are modulated in width and sequence timing to control the amount of energy that is driving the Luminaire Light Engines (27). The Luminaire PWM Driver (26) power supply can also be used to control motor speed. Those skilled in the art will know that selective harmonics must be eliminated in PWM motor control circuits

This invention defines a PWM module (26) capable of parametrically evaluating a multiplicity of periods and duty cycles that optimize the resonance of the equivalent inductance L and capacitance C in a LC Tank circuit of Luminaire Light Engines (27).

This invention defines a PWM module capable of very high pulse rates can be used to modulate the optimized PWM resonance DC pulse train driving the Luminaire Light Engines (27) for free space optical data transmission.

This invention defines a plurality of PWM Luminaire Light Engines (27) that can operate concurrently at different wavelengths allowing increased data rates.

### 27 Luminaire Light Engines

The Luminaire Device Network [LDN] (4) refers to a multiplicity of modules that are configured to create a specific set or individual instance of an intelligent luminaire (Lighting Fixture). Solid State Lighting [SSL] uses Light Emitting Diodes [LED]s and or Laser Diodes in plurality to configure a variety of SSL Luminaire Light Engines (27). Luminaire Light Engines (27) can be configured for wavelength/frequency, color temperature, radiant luminosity, radiation dispersion patterns and in combinations.

The Luminaire Device Network [LDN] (4) may include one or more Luminaire Light Engines (27) to satisfy the design criteria.

### 28 Luminaire Power Supplies

Luminaire power supplies are required to take the Power over Ethernet [PoE] DC voltages and convert them to the multiplicity of DC voltages required for the set of LDN (4) modules to construct and configure an intelligent luminaire. DC to DC converters is the electrical engineering term used to define these types of power supplies.

### 29 Luminaire Modules Actuators

Luminaire Actuator Modules are used to generate, disperse and move things. These modules can be configured on a LDN (4) to add specific features and capabilities.

### 30 Luminaire Modules Imagers

Luminaire Imaging Modules (30) add a wide range of cameras covering different wavelengths, frame rates, dynamic ranges, bit depths, spatial resolutions, lenses, positioners, mountings and configurations in the LDN (4). Additional Luminaire Imaging Modules (30) may provide Motion Capture [MoCAP], Gestural capture, 3D point clouds from Time Of Flight [TOF] imagers and other related imaging sensors.

### 31 Luminaire Modules Sensors

Luminaire Sensor Modules (31) are used to indicate a vast array of parameters and values related to defining the physical conditions the LDN (4) is placed in. Luminaire Sensor Modules (31) addresses a wide range of sensors and detectors that may be required to provide the confirmation, concentration or absence of an element, substance, compound, physical property, electromagnetic property, radioactive property or related properties existing around the LDN (4).

### 32 Luminaire Modules Transducers

Luminaire Transducer Modules (32) can receive and create vibrations. These devices can detect earthquakes, sound and vibrations over a wide range of frequencies. In addition these Luminaire Transducer Modules (32) can create specific ranges of vibrations that could be used to construct a noise cancelling luminaire for example.

### 33 Luminaire Modules Transceivers

Luminaire Transceiver Modules (33) cover a wide range for radios for detection, reception and transmission of analog and digital information over a wide range of frequencies and modulation techniques. Luminaire Transceiver Modules (33) may be used to detect the presence of a specific device such as a mobile phone with a specific EIN number that could be a factor in a multifactor authentication. Other Luminaire Transceiver Modules (33) can establish full duplex communications.

### 34 Power and Network Interface

The Power and Network Interface (34) allows the LDN (4) to receive Power over Ethernet [PoE] and provide transmit and receive lines for Ethernet data communications between the LDN (4) through the NWS (1) to the LCS (3).

This PoE network interface may also include a LDN (4) PoE pass through ether net switch to facilitate the connection of LDN (4) modules that do not require direct interface with the MCU (35).

### 35 Luminaire Microcontroller Unit [MCU]

The Luminaire Microcontroller Unit [MCU] (35) will provide the LDN (4) intelligence by combining compute, storage, networking, interface inputs and outputs, digital signal processing, pulse width modulation, data encryption, lights out management and related features in a LDN (4) Module.

Different and multiple Luminaire Microcontroller Units [MCU] (35) may be required to satisfy design criteria.

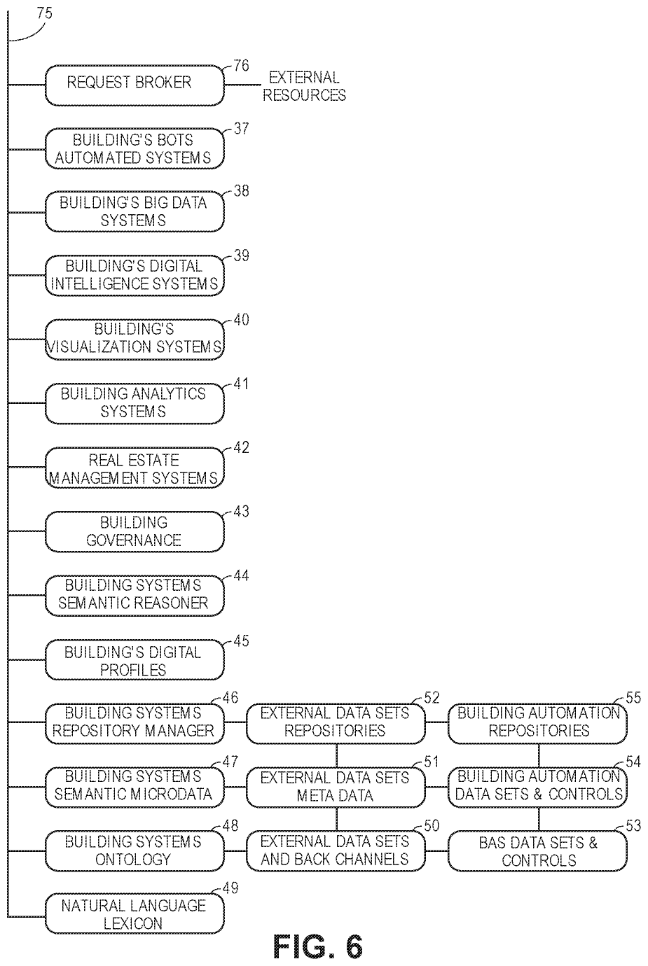

### FIG. 5 Relevance Based Digital Building Information Architecture Overview

### 55 Smart Building Automation and Data Repository Systems

Smart Building Automation and Data Repository Systems allows the RBDB system to access legacy Building Automation [BAS] systems and the related data repositories for integration into the RBDB.

### 56 Network Lighting Systems Data Acquisition and Management

Network Lighting Systems are comprised of Intelligent Luminaires. Intelligent Luminaires have a Luminance Intelligence Module [LIM] that provides programmable control of a wide range of sensors, detectors, communications and actuators that make up the Luminaire Device Network [LDN].

The Luminaire Device Network [LDN] generates a panoply of data that must be Acquired and managed for integration into the RBDB digital intelligence systems.

### 74 Stakeholder Real Intelligence and Artificial Intelligence Information Architecture

The owners, operators, managers, employees, tenants, customers and visitors of the building are collectively referred to as Stakeholders. The Stakeholder Information Architecture creates structured data required to understand the requirements, preferences, roles, rights, privileges, rules. behavior patterns, and all other related information the RBDB system operators wish to include. Stakeholder real intelligence is captured and formatted as structured data and then augmented with artificial intelligence to seek goals defined by users.

### 75 Building Artificial Intelligence Information Architecture

The Building Artificial Intelligence Information Architecture allows the building to become Self-Aware. Being self-aware the building behaves like a person. The Building Artificial Intelligence Information Architecture provides the interoperability between the building systems, legacy building automation systems, machine to machine interoperability, other buildings interoperability, and building to stakeholder interoperability, and stake holder to stakeholder interoperability.

### 76 Stakeholders and Buildings API Application Programming Interface Systems

The Stakeholders and Buildings API Application Programming Interface Systems provide the ability to define and create internal and external interface with other data systems. These APIs allow advanced remote control, data exchange and interoperability between disparate systems.

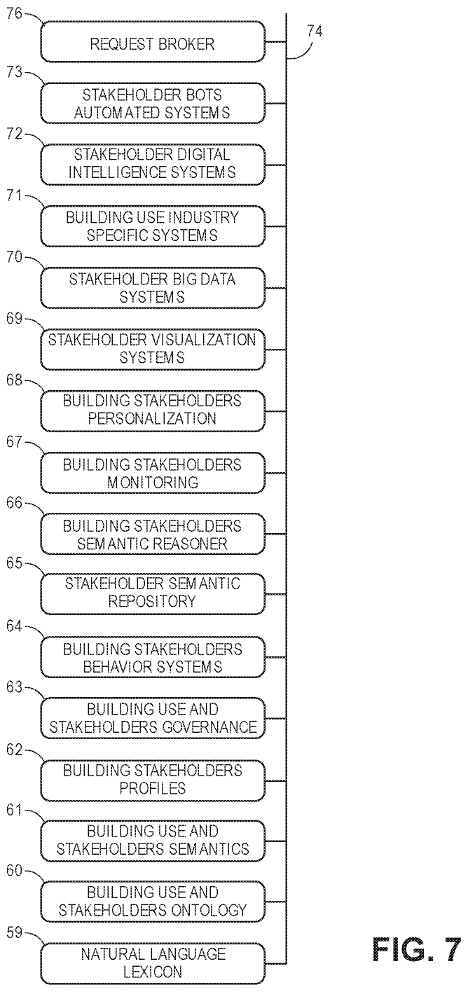

### FIG. 6 Digital Building Artificial Intelligence Information Architecture

FIG. 5 Relevance Based Digital Building Information Architecture [RBIA] The invention defies a novel Relevance Based Digital Building Information Architecture (FIG. 5.) as defined in FIG. 5 that leverages the NLS (0) systems that are ubiquitous in an intelligent digital building to create digital building intelligence, building self-awareness, digital personas for the building and the building's stakeholders.

These digital personas allow high relevance interactions between the digital intelligence exhibited by the building and augmented human intellect enabled by the digital intelligence systems for the stakeholders.

### 37 Building's Bots

Digital Building Intelligence is manifested and personified through a multiplicity of mechanisms for Machine to Machine [M2M] and machine to stakeholder interactions. These interactions can include; alerts, status messages, alarms, request messages, transactions, memorandums, legal notices and related communications required for living.

Digital Building Intelligence may utilize BOTS as automated processes that allows the building to communicate with other BOTS, people and stakeholders to conduct their affairs.

### 38 Building's Big Data Systems

The Buildings Digital Intelligence Systems (39) and the NLS (0) will generate massive quantities of data in an ongoing basis. These large data sets are called Big Data. Big Data provides a valuable resource of actual usage and operational data that drives a multiplicity of uses.

### 39 Building's Digital Intelligence Systems

The building's NLS (0) and other Building Automation Systems [BAS] combined with real time analytics start to develop a basis for a Digital Intelligence System [DIS]. The building would have a digital persona that defines a set of principles that are manifested in a software agent. The building's software agent is made aware of its environment internally and its place in the real world externally. The Digital Intelligence now has the capability to interact with other agents through Building's Digital Profiles (45).

### 40 Building's Visualization Systems

Massive amounts of data generated by the Buildings Digital Intelligence Systems (39) and the NLS (0) will be presented through data visualization systems. The Building's Visualization Systems (40) will format data form the building's systems to be presented as visual information. This visual information can range from simple graphs to complete immersive 3D virtual worlds.

### 41 Building's Analytics Systems

Building's Analytics Systems (41) are used to analyze and correlate data. The Building's Analytics Systems transform raw data into decision support information. Data collection from the Building's Systems Repository Manager (46) includes data interchange with External Data Set Repositories (52), Building Automation Repositories (55) and NLS Data Repositories (58). Building's Analytics Systems (41) will evaluate data integrity, clean the data and prepare it for analysis. The Relevance Based Digital Building Information Architecture [RBA] (36) incorporates a multiplicity of data analysis techniques to deliver the data analysis.

### 42 Real Estate Management Systems

Real Estate Management Systems (42) are used to track site selection, project management, capital planning, budget management, building purchases, lease administration, partnerships, facilities management, asset management operations, maintenance, over the facilities lifecycle. Real Estate Management Systems will provide real time data to support Building's Analytics Systems (41) and Building's Digital Intelligence Systems (39).

### 43 Building's Governance Systems

Building's Governance Systems (43) provide digital information related to local, state and federal, legal and regulatory framework related to design, permitting, inspections, occupancy permits, zoning and permitted usage. These policies and procedures and accounting practices must be communicated in a structured digital format to support Building's Analytics Systems (41), Building's Bots (37), and Building's Digital Intelligence Systems (39).

### 44 Building's Systems Semantic Reasoner

Building's Systems Semantic Reasoner (44) is a semantic inference engine that provides digital intelligence by inferring what the agent and environment interaction is at any given state. The Building's Systems semantic reasoner, reasoning engine, rules engine, or simply a reasoner, is software that infers logical consequences from a set of asserted facts or axioms driven from the Building's Analytic Systems (41), Real Estate Management Systems (42), Building's Governance Systems (43), Building's Systems Repository Manager (46), and the Building's Digital Profiles (45). The Building's Systems Semantic Reasoner (44) may also be communicating with the Building's Bots (37) to facilitate M2M and machine to human communications and transactions.

### 45 Building's Digital Profiles

Building's Digital Profiles (45) provides the ability to define a set of human type qualities onto an inanimate object like a building. The Building's Digital Profiles (45) organize a multiplicity of information that parallels how a human may interact with another human The Building's Digital Profile (45) may treat a specific individual or company with preferential treatment due to a familial relationship. Other vendors may be address in a hard line negotiating position because the owners of the building have required this policy to reflect their own. The Building's Digital Profiles (45) are a plurality of profiles that will be selected by the Building's Systems Semantic Reasoner (44) to manage the relevant building's digital personas.

### 46 Building's Systems Repository Manager

Building's Systems Repository Manager (46) will coordinate the management of data from a multiplicity of data repositories. This includes data management with External Data Set Repositories (52), Building Automation Repositories (55) and NLS Data Repositories (58) providing a universal interface to the Building's software buss (75).

### 47 Building's Semantic Micro Data

Building's Semantic Micro Data (47) represents a collection of Meta data used to tag raw essence data with a controlled vocabulary defined in the Building Systems Ontology (49) and the Natural Language Lexicon (49). The creating and management of this Meta dat provides the ability to drive the Building's Systems Semantic Reasoner (44).

### 48 Building's Systems Ontology

The Building's Systems Ontology (48) defines a schema that organizes a controlled vocabulary for the knowledge domains and their interrelationships relevant to the building. The Building's Systems Ontology (48) will define the schemas, with properties, types and descriptions for every entry in the Building's Systems Ontology (48).

### 49 Natural Language Lexicon

A lexicon is the vocabulary of a person, language, or discipline of knowledge (such as Real Estate or Medical). As each natural language evolves and addition words and meanings are added a set of agreed upon lexical usage is defined concurrent with area of interest domains that may offer additional words, meanings such as Slang terms, Jargon for an area of interest and colloquialisms. Each definition of a specific word can be identified as there may be multiple meaning for any given work.

The Relevance Based Digital Building Information Architecture (FIG. 5.) incorporates large lexical databases of natural languages. Nouns, verbs, adjectives and adverbs are defined and also grouped into sets of cognitive synonyms (synsets), each expressing a distinct concept. Synsets are interlinked by means of conceptual-semantic and lexical relations.

### 50 External Data Sets & Back Channels

External Data Sets & Back Channels (50) provides the interfaces to private and public data sources. The Relevance Based Digital Building Information Architecture [RBA] (36) requires a multiplicity of information sources to deliver current pricing, time and date, data from other buildings and complexes owned or managed by the same group, other private data sources and the WWW Internet.

### 51 External Data Sets & Back Channels Meta Data

These External Data Sets (51) may contain unstructured and structured data sets. Most unstructured data will need to be structured to be used in The Relevance Based Digital Building Information Architecture [RBA] (36). This is accomplished by the RBDB data models, semantic tagging, Meta tagging, micro tagging and RBDB ontology schema to enhance its relevance and use.

### 52 External Data Sets Repositories

External Data Sets Repositories will provide persistence for a multiplicity of external data sets. These External Data Sets may contain unstructured and structured data sets. Some unstructured data may be structured, Meta tagged, micro tagged and schema driven to enhance its relevance and will be stored in these repositories.

### 53 Building Automation Systems [BAS] Data Sets and Controls

The NLS (0) is one of a plurality of Building Automation Systems [BAS] that together will provide a large portion of the status and control points for a building. Each BAS system will generate valuable data sets that will feed information to create higher level of digital intelligence. Concurrently the BASs will accept command controls to modify their operation to achieve the stated goals and real time responsiveness.

### 54 Building Automation Systems [BAS] Data Sets and Controls Meta Data

These Building Automation Systems [BAS] Data Sets may contain unstructured and structured data sets. Most unstructured data will need to be structured to be used in The Relevance Based Digital Building Information Architecture [RBA] (36). This is accomplished by the RBDB data models, semantic tagging, Meta tagging, micro tagging and RBDB ontology schema to enhance its relevance and use.

### 55 Building Automation Systems [BAS] Data Sets Repositories

Building Automation Systems [BAS] Data Sets Repositories will provide persistence for a multiplicity of external data sets. These Building Automation Systems [BAS] Data Sets may contain unstructured and structured data sets. Some unstructured data may be structured, Meta tagged, micro tagged and schema driven to enhance its relevance and will be stored in these repositories.

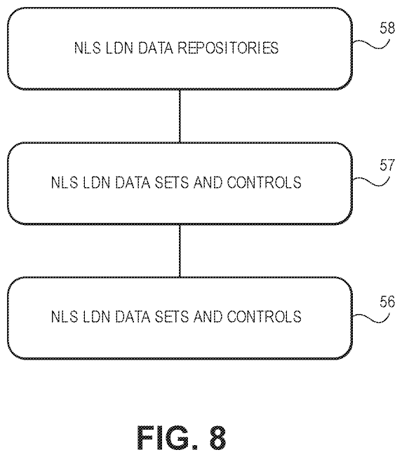

### FIG. 7 Stakeholder Real Intelligence and Artificial Intelligence Information Architecture

### 59 Natural Language Lexicon

A lexicon is the vocabulary of a person, language, or discipline of knowledge (such as Real Estate or Medical). As each natural language evolves and addition words and meanings are added a set of agreed upon lexical usage is defined concurrent with area of interest domains that may offer additional words, meanings such as Slang terms, Jargon for an area of interest and colloquialisms. Each definition of a specific word can be identified as there may be multiple meaning for any given work.

The Relevance Based Digital Building Information Architecture [RBA] (36) FIG. 5, incorporates large lexical databases of natural languages. Nouns, verbs, adjectives and adverbs are defined and also grouped into sets of cognitive synonyms (Synsets), each expressing a distinct concept. Synsets are interlinked by means of conceptual-semantic and lexical relations. This instance of the Lexicon will be defined for human stakeholders.

### 60 Building's Use and Stakeholders Ontology

The Building's Use and Stakeholder Ontology (60) defines a schema that organizes a controlled vocabulary for the knowledge domains and their interrelationships relevant to the building. The ontology will define the schemas, with properties, types and descriptions for every entry in the ontology.

### 61 Building's Use and Stakeholders Semantics

Building's Use and Stakeholders semantic (61) data will define the data model and structure the data to be used in The Relevance Based Digital Building Information Architecture [RBA] (36). This is accomplished by the RBDB data models, semantic tagging, meta tagging, micro tagging and Building's Use and Stakeholder Ontology (60) schema to enhance its relevance and use.

### 62 Building's Stakeholders Profiles

Building's Stakeholders Digital Profiles (62) provides the ability to define a set of digital personas that define a set of roles any one person can have. The Building's Stakeholders Digital Profiles (62) organize a multiplicity of information that defines how a human may interact with another human digitally.

The Building's Stakeholders Digital Profile (62) will include a set of Digital Personas. Each individual may assume a plurality of roles and responsibilities that need to be communicated to other Digital Personas including the buildings Digital Persona.

If an individual is the Building Owner, Medical Doctor, Tennant, Patient a digital persona would exist for each role. This process allows high relevance information to be presented in context to the functioning role at any point in time. Individuals define which Digital Personas they are presenting at any point of time. This way if the individual is a patient in his medical practice in his building under another doctors care he will be treated as a patient until released.

### 63 Stakeholders Governance Systems

Stakeholders Governance Systems (63) provide digital information related to employee, contractors, consultants local, state and federal, legal and regulatory framework. Stakeholders represented as owners, partners, stock holders, board of directors', executives and staff are all governed and abide by the bylaws, operating agreements and business practices agreements.

### 64 Building's Stakeholders Behavior Systems

Building's Stakeholders Behavior Systems (64) provides the ability to define a set of idiosyncratic behaviors that are linked to an individual's digital personas. The ability to capture and semantically tag an individual's specific behavior patterns allow exceptions to these patterns to be flagged and addressed accordingly.

### 65 Stakeholders Semantic Repository

Stakeholders Semantic Repository (65) will provide the persistence for all of the semantic data required by the Natural Language Lexicon (59), Building's Use and Stakeholder Ontology (60), Building's Use and Stakeholders Semantics (61), Building's Stakeholders Profiles (62), Stakeholders Governance Systems (63), Building's Stakeholders Behavior Systems (64)

### 66 Building's Stakeholders Semantic Reasoner

Building's Stakeholders Semantic Reasoner (66) is a semantic inference engine that provides digital intelligence by inferring what the agent and environment interaction is at any given state. The Building's Stakeholders Semantic Reasoner (66), reasoning engine, rules engine, or simply a reasoner, is software that infers logical consequences from a set of asserted facts or axioms driven from the Stakeholders software buss (74) to facilitate high relevance machine to human and digitally enhanced human to human communications and transactions.

### 67 Building's Stakeholders Monitoring Systems

Building's Stakeholders Monitoring Systems (67) compares Building's Stakeholders Behavior Systems (67) data for each individual in the building to determine congruent or in congruent behavior. The ability to capture and semantically tag an individual's specific behavior patterns allow a semantic weighting value to be assigned these patterns to be flagged and addressed accordingly.

### 68 Building's Stakeholders Personalization Systems

Building's Stakeholders Personalization Systems (68) provide the ability of an individual, group of individuals, department, floor and any set of individuals to adapt their workspaces within the stakeholders set boundaries. These Building's Stakeholders Personalization Systems (68) will communicate will systems on the Stakeholder Software Buss (74) and use the Request Broker API (72) to communicate with the NLS Data Sets and Control (57) and the Building Automation System Data Sets and Controls (54) to adjust lighting, temperature, cameras, sensors, actuators and other parameters available and permissible.

### 69 Stakeholder Visualization Systems

Massive amounts of data generated by the Stakeholder Digital Intelligence Systems (72) will be presented through data visualization systems. The Stakeholder Visualization Systems (69) will format data form the Stakeholder's systems to be presented as visual information. This visual information can range from simple graphs to complete immersive 3D virtual worlds.

### 70 Stakeholder Big Data Systems

The Stakeholder Digital Intelligence Systems (72) and other systems on the Stakeholders software buss (74) will generate massive quantities of data in an ongoing basis. These large data sets are called Big Data. Big Data provides a valuable resource of actual usage and operational data that drives a multiplicity of uses.

### 71 Building Use Industry Specific Systems

Building Use Industry Specific Systems (71) provide the ability to define and model a set of industry and use case instance specific parameters that aids the relevance of information to stakeholders. Some industries have special machinery that requires certain power and generates specific vibration profiles that need to be defined as normal by the stakeholders to communicate to the buildings systems. Other industries may routinely handle hazardous materials that need to have their proper handling and disposal defined by stakeholders and communicated to the buildings systems.

### 72 Stakeholders Digital Intelligence Systems

The Stakeholders Digital Intelligence Systems (72) deliver high relevance digital intelligence by combining all of the data sources on the Stakeholders Software Buss (74) with real time analytics, machine learning, digital cognition and related techniques.

### 73 Stakeholders Bots

Digital Intelligence is manifested and personified through a multiplicity of mechanisms for Machine to Machine [M2M] and machine to stakeholder interactions. These interactions can include; alerts, status messages, alarms, request messages, transactions, memorandums, legal notices and related communications required for living.

Digital Intelligence may utilize Stakeholders BOTS as automated processes that allows the building to communicate with other BOTS, people and stakeholders to conduct their affairs.

### 74 Stakeholders Software Bus

Stakeholders Software Bus is a software architecture model where a shared communication channels facilitates connections and communication between software modules. All of the software modules in the Stakeholders information architecture are able to exchange data this includes:
Natural Language Lexicon (59)
Building's Use and Stakeholders Ontology (60)
Building's Use and Stakeholders Semantics (61)
Building's Stakeholders Profiles (62)
Stakeholders Governance Systems (63)
Building's Stakeholders Behavior Systems (64)
Stakeholders Semantic Repository (65)
Building's Stakeholders Semantic Reasoner (66)
Building's Stakeholders Monitoring Systems (67)
Building's Stakeholders Personalization Systems (68)
Stakeholder Visualization Systems (69)
Stakeholder Big Data Systems (70)
Building Use Industry Specific Systems (71)
Stakeholders Digital Intelligence Systems (72)
Stakeholders Bots (73)
Request Brokers Application Programming Interfaces [API] (76)

### 76 Request Brokers Application Programming Interfaces [API]

Request Brokers Application Programming Interfaces [APIs] are used to connect the buildings Software Bus and respective modules to the stakeholders' Software Bus and respective modules. Request Brokers Application Programming Interfaces [APIs] may also be used to interface and exchange data with external sources.

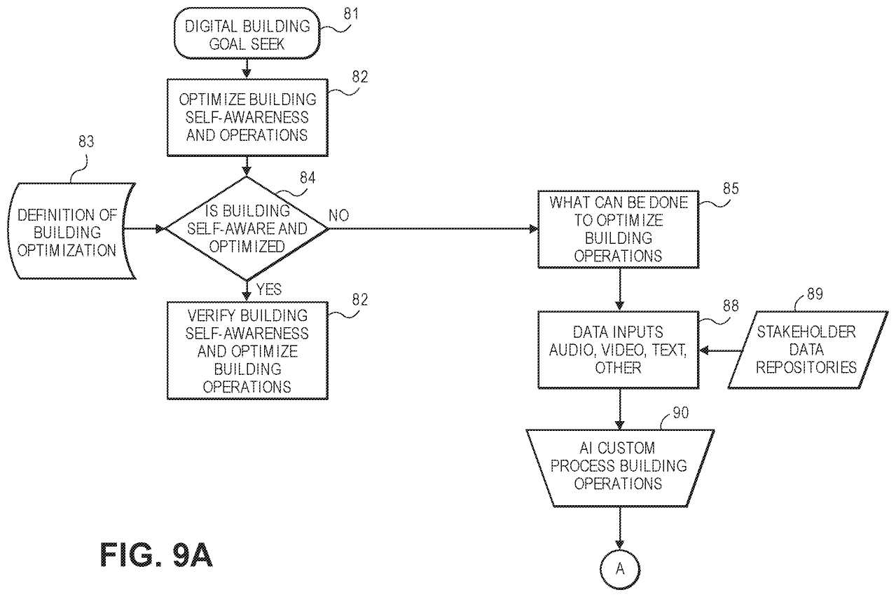

### FIG. 8 Network Lighting System [NLS] Information Architecture

### 56 Network Lighting System [NLS] Data Sets & Controls

NLS (0) Data Sets & Back Channels provides the interfaces to private and public data sources. The Relevance Based Digital Building Information Architecture [RBA] (36) requires a multiplicity of information sources to deliver current pricing, time and date, data from other buildings and complexes owned or managed by the same group, other private data sources and the WWW Internet.

### 57 Network Lighting System [NLS] Data Sets and Controls Meta Data

These Network Lighting System [NLS] (0) Data Sets may contain unstructured and structured data sets. Most NLS (0) data will be structures due to its origination in the LCS (3), unstructured data will need to be structured to be used in The Relevance Based Digital Building Information Architecture [RBA] (36). This is accomplished by the RBDB data models, semantic tagging, Meta tagging, micro tagging and RBDB ontology schema to enhance its relevance and use.

### 58 Network Lighting System [NLS] Data Sets Repositories

Network Lighting System [NLS] (0) Data Sets Repositories will provide persistence for a multiplicity of external data sets. The Network Lighting System Data Sets may contain some unstructured and structured data sets. Some unstructured data may be structured, Meta tagged, micro tagged and schema driven to enhance its relevance and will be stored in these repositories.

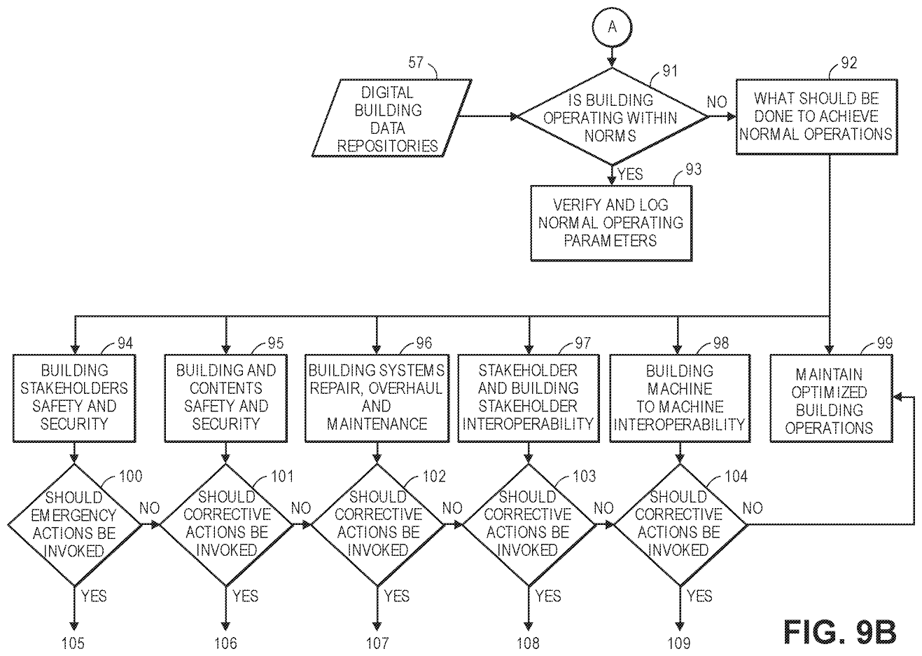

### FIG. 9A, 9B Relevance Based Digital Building Flow Chart

The Relevance Based Digital Building utilizes advances in Artificial Intelligence and Deep Learning to create a digital building that is Self-Aware. The building takes on one or more Digital Personas that allows the building to interact with people as if the Digital Building was a person.

The Relevance Based Digital Building has two distinct information architectures the Buildings Stakeholders Information Architecture 74 and the Digital Buildings Information Architecture 75. The Stakeholders Information Architecture 74 captures the real intelligence and behavior of everyone connected and associated with the Digital Building. The Stakeholders Information Architecture 74 adds Artificial Intelligence [AI] to augment the real intelligence captured and managed in the Stakeholders Information Architecture 74.

The Digital Buildings Information Architecture 75 manages the Intelligent Luminaires which make up the Network Lighting System [NLS] 0. The NLS acts as the sensory system for the Digital Buildings Information Architecture 75. Together the NLS 0 and the Digital Buildings Information Architecture 75 provides the capabilities for the Digital Building Intelligence (Self-awareness.

With the combined capabilities of the Network Lighting System [NLS] 0 and the Buildings Stakeholders Information Architecture 74 and the Digital Buildings Information Architecture 75 the Relevance Based Digital Building can be tasked with a Goal to Seek as represented in FIGS. 9A and 9B Relevance Based Digital Building Flow Chart.

81 Authorized and authenticated users of the Relevance Based Digital Building can set forth one or more Goals for the building to seek.

82 The users set a goal to optimize the buildings self-awareness and operations.

83 The users program in a set of rules, definitions, data dictionary and related data structure as required defining building optimization.

84 The system will then be queried to decide if the building is self-aware and optimized based on the criteria set for the in item 83.

85 Should the decision be no the building is not optimized then the building will ask its self what can be done to optimize the buildings operations since it is self-aware.

86 Should the building decision be that it is optimized through its self-awareness, then the building will go through its prioritized processes to verify that the building is optimized.

87 The decision as to whether the building is optimized or not item 84 is determined by having the Relevance Based Digital Building consult the Definitions of Building Optimization 83 and the Digital Building Data Repositories 87 that contain stored and real time building status information.

88 In determining What Can be Done to Optimize Building Operations 85 the Relevance Based Digital Building may input a variety of data sources to aid this process. Text, Images, Video, Audio, Vibration graphs and other information may be input to seek the goal of optimization.

89 One major component of determining if the building is optimized is the Stakeholder Data Repositories. These information volumes are used to train the AI and Deep Learning so the buildings bots can be sent to perform tasks.

90 Factoring all of the data into information into knowledge, into multi factor knowledge into wisdom and into action will take place to create processes for AI driven building operations.

91 As the AI processes in 90 are executed and observed the building is able to decide if it is operating within the Norms defined in 83.

92 Should the activities and operation of the building be abnormal then the building shall identify one or more actions that it can take to have the building and its stakeholders operating within the Norms of normal operation.

93 Should the building find that it is operating within the norms of normal operation that the building will log and verify these parameters.

94 If the building is in abnormal operations is there a threat to the safety and security of the buildings stakeholders.

95 If the building is in abnormal operations is there a threat to the safety and security of the building and its contents.

96 If the building is in abnormal operations is there an issue related to the Repair, Overhaul and Maintenance of the building.

97 If the building is in abnormal operations is there an issue related to the stakeholder to stakeholder interoperability. Or is there an issue of the stakeholder to building interoperability.

98 If the building is in abnormal operations is there an issue related to the Machine to Machine [M2M] interoperability.

99 if the building is operating in its optimized condition then it shall maintain this condition.

100 Should the building or its stakeholders find that there is a threat to the safety and security of the buildings stakeholders should emergency procedures be invoked.

101 If the building is in abnormal operations and there is a threat to the safety and security of the building and its contents should corrective actions be taken.

102 If the building is in abnormal operations and there is an issue related to the Repair, Overhaul and Maintenance of the building should corrective actions be taken.

103 If the building is in abnormal operations and there is an issue related to the stakeholder to stakeholder interoperability. Or there is an issue of the stakeholder to building interoperability should corrective actions be taken.

104 If the building is in abnormal operations and there is an issue related to the Machine to Machine [M2M] interoperability should corrective actions be taken.

105 Emergency actions invoked.

106 Corrective actions invoked.

107 Corrective actions invoked.

108 Corrective actions invoked.

109 Corrective actions invoked.

### DETAILED DESCRIPTION OF THE INVENTION

A Network Lighting System (0) is configured from a multiplicity of application specifically configured Intelligent Luminaires. The intelligent luminaires integrate a plurality of modules as required to address each intelligent luminaires usage. A Luminaire Device Network [LDN] (4) consisting of Luminaire Intelligence Modules [LIM] is configured from one or more Luminaire Microcontroller Units (35) interfaces with a multiplicity of modules defined in the LDN (4).

The plurality of LDN (4) modules;

| | | |
|---|---|---|
| (26) | LDN | Luminaire PWM Driver |
| (27) | LDN | Luminaire Light Engines |
| (28) | LDN | Luminaire Power Supplies DC to DC |
| (29) | LDN | Luminaire Modules Actuators |
| (30) | LDN | Luminaire Modules Imagers |
| (31) | LDN | Luminaire Modules Sensors |
| (32) | LDN | Luminaire Modules Transducers |
| (33) | LDN | Luminaire Modules Transceivers |
| (34) | LDN | Power and Network Interface |
| (35) | LDN | Luminaire Microcontroller Unit [MCU] |

The invention includes advanced Pulse Width Modulation [PWM] (26) of Solid State Lighting engines (27) in the [SSL] Luminaire Device Networks [LDN] (4). The PWM driver circuit (26) can be tuned to the quasi resonance of the equivalent LC tank circuit of the Solid State Lighting engines (27) and significantly reduce the power consumption. Additionally higher frequency PWM modulations within the optimized resonance PWM waveform provide the ability to transmit data optically through free space optics.

The NLS (0) network distributed throughout a building not only provides advanced intelligent luminaires that can adjust to ambient light levels, be tuned for specific color temperatures and color rendering indexes but becomes the sensory network for a new digital building intelligence system. This ubiquitous distributed intelligent lighting system enables the interoperability between the Digital Building Intelligence and Augmented Stakeholder Intelligence. Together they deliver a Relevance Based Digital Building [RBDB].

Now we have a sensory, actuator and communications network built as defined in the NLS (0). The NLS (0) connects to the Relevance Based Digital Building Intelligence Information Architecture as defined in (FIG. 5) creating Digital Building Intelligence.

### Network Lighting System [NLS]

The Relevance Based Digital Building can be constructed connecting with the intelligent Network Lighting System [NLS] (0). The NLS (0) will be constructed from the following components:
1. [NWS] Power over Ethernet Network Switches (1)
2. [ICS] Intelligent Control Surfaces (2)
3. [LCS] Lighting Control Systems (3)
4. [LDN] Luminaire Device Networks (4)

Together these components will deliver illumination, imagers, actuators, sensors and control that provide data collection and interaction with the stakeholders in any building.

### Power Over Ethernet Network Switches [NWS]

Power over Ethernet [PoE] Network Switches [NWS] (1) will deliver power and data packets to and from any devices connected to them. Their interconnection defines the network topology as to how controller and controller devices will communicate. The NWS (1) serves as the framework for the interconnection of all NLS (0) devices thus the name Network Lighting Systems [NLS] (0). The NLS (0) network may be configured a separate network from the Information Technology [IT] networks and therefore may include its own routers, firewalls, Demilitarized Zone [DMZ] and Wide Area Network [WAN] connections.

The preferred embodiments would use Institute of Electrical and Electronics Engineers [IEEE] standards based PoE NWS (1) that are compliant PSE switches. The IEEE standards should include:
IEEE 802.3af [PoE] 12.95 Watts
IEEE 802.3at [PoE+] 25.5 Watts
IEEE 802.3BT [PoE++] 49 Watts

All devices in the NLS (0) are connected to the NWS (1) this includes Intelligent Control Surfaces [ICS] (2), Lighting Control Systems [LCS] (3) and Luminaire Device Networks [LDN] (4). A multiplicity of network topologies may be used to create the NLS (0).

### Intelligent Control Surfaces [ICS]

Intelligent Control Surfaces [ICS] (2) refers to a family of devices that have the ability to connect to the Network Switches [NWS] (1) so that they can communicate with the Lighting Control System [LCS] (3).

Some of the ICS (2) devices would be Ethernet keypads in the preferred embodiment. The Ethernet keypads would have the ability to send and receive data packets over the NWS (1) to and from the LCS (3). These data packets would be interpreted by the LCS (3) and the corresponding data packets would be sent to affected devices on the NWS (1). The Ethernet keypads would also be able to draw power from the NWS (1) to drive displays, backlights, indicators, annunciators, and on board electronics.

Additional ICS (2) could be computers, handheld devices such as smart phones, tablets and mobile computers. These devices would be configured with required software to gain access to one or more NLS (0) systems and interact with the system for a variety of uses.

### Lighting Control System [LCS]

A hardware and software based Lighting Control System [LCS] (3) will perform a multiplicity of functions as required to command control and communicates with all the components of the Network Lighting System [NLS] (0). In the preferred embodiment the LCS (3) is a Commercial Off The Shelf [COTS] industry standard high availability scalable computing environment that can be configured to address small to large buildings that may incorporate multiple building complexes. This industry standard computing platform will also include COTS software for Operating System [OS] and custom software. The LCS (3) will consist of a computing environment required to deliver the framework for the following NLS (0) main functions:
1. NLS System Configuration
2. NLS System Operations
3. NLS Remote Access

### LCS Hardware Platform

The preferred embodiment would utilize industry standard commercial off the shelf computers that would have the hardware and software required to deliver the NLS (0) functions. The LCS (3) hardware platform may be a small industrial Personal Computer [PC] for some installations and a rack of compute and storage blades for other large scale installations.

The computing platform requirements would include the following:

| | |
|---|---|
| Redundant Power Supplies | Intelligent Platform Management |
| BIOS | Interface [IPMI] |
| Central Processors | Lights Out Management |
| System Memory | KVM over IP |
| CPU Cooling | NVMe |
| Mother Board/Blade Cooling | Virtual Media over LAN |
| SATA | PCIe Bus Slots |
| Solid State Drives | Display Adapters |
| Hard Disk Drives | LED Indicators |
| Network Controllers | Graphics Processing Units |

### NLS Software Architecture

The NLS (0) LCS (3) will leverage a Service Oriented Architecture [SOA] for the communications between software modules. The SOA software messaging bus will be deployed on a n-tier Client/Server architecture using a domain driven design. This approach will leverage many industry standard practices with the enhancement of Semantic Object Oriented Business Domains.

NLS (0) software architecture in the LCS (3) will create a Universal Database Manager (17) to coherently manage a multiplicity of database repositories. Each type of repository has advantages for specific schemas, and data types. The LCS (3) software environment will be interoperating with unstructured and structured data and the database management systems that reflect each specific implementation. The LCS (3) universal database manager will deliver a common software interface across all data base management systems.

### Object Relational Database Management System [ORDBMS]

An Object Relational Database [ORD], or Object Relational Database Management System [ORDBMS] (21), is a Data Base Management System [DBMS] similar to a relational database, but with an object-oriented database model. Software objects, classes and inheritance are directly supported in database schemas and in the query language. In addition, just as with pure relational systems, it supports extension of the data model with custom data-types and methods. The LCS (3) may require ORDMS (21) to provide the data management required.

### Resource Description Framework [RDF] Triplestores

RDF Triplestores (19) are extended from web-centric resources to include business domain semantics. Similar to a relational database, one stores information in a triplestore and retrieves it via a query language. Dissimilar to an object relational database or a relational database, a triplestore is optimized for the storage and retrieval of triples. In addition to queries, triples can usually be imported/exported using Resource Description Framework [RDF] and other formats. A triplestore or RDF store is a purpose-built database for the storage and retrieval of triples through semantic queries. A triple is a data entity composed of subject, predicate, object.

### Data Base Management System [DBMS]

Database Management System [DBMS] (20) is a collection of software applications that interacts with the user, other applications, and the database itself to capture and analyze data. A general-purpose DBMS (20) is designed to allow the definition, creation, querying, update, and administration of databases. The LCS DBMSs may include MySQL, PostgreSQL, Microsoft SQL Server, Oracle, Sybase, SAP HANA, and IBM DB2.

### Cloud Storage

Cloud Storage (18) represents all external data repositories that the LCS (3) may require for creating, configuration, operation, maintenance and enhancement of the LCS (3). External data repositories may include external data feeds or information access, disaster recovery data volumes and other related uses as required by the LCS (3) and clusters of LCSs (3).

### Data Access Layer

The Data Access Layer (16) manages the data repository connectivity allowing persistence of objects and data that will be managed in the LCS (3). Since the LCS (3) has advanced meta and micro data capabilities required to create digital intelligence the data layer must deal with Resource Description Framework [RDF] allowing the structuring of internal and external www resources for LCS (3) operation.

### Business Logic

Domain logic or business logic is part of the LCS (3) software that deals with the business rules that control how data is created, displayed, stored, and changed. It is used in concert with other layers to define the operational capabilities of the LCS (3).

### Data Visualization Engine

The Data Visualization Engine (25) is used to present data sets as graphs, graphics, images, pictures, 3D models and visual data sets. These software engines are configured to accept data sets and streams and overlay information on them render the visual information and preprocess all data that may need to be visualized.

### Data Security

Data Security (13) covers a wide range of issues required to design, construct, deploy, operate and maintain the LCS (3). Security software will handle Identity Based Security authentication, authorization, rights and privileges for each user. Data security may include;

| | |
|---|---|
| Data Copy Protection | Pre-boot authentication |
| Data erasure | Privacy engineering |
| Data masking | Secure USB drive |
| Data recovery | Security Breach Notification Laws |
| Digital inheritance | Single sign-on |
| Data Encryption | Smart card |
| Trusted Computing Group | Obfuscation |

### Client Rendering

The presentation layer in the client/server implementation of the LCS (3) software application may be used on a variety of Intelligent Control Surfaces [ICS] (2). Each of the ICS (2) specific devices have a number of parameters that affect the user experience UX and are addressed through Client Rendering (12). Client Rendering (12) handles all the target devise requirements to deliver a successful interaction with the LCS (3) users.

### Data & Streaming

The LCS (3) is a point of coordination for many of the NLS (0) components. Because the LCS (3) will be handling data from the Luminaire Device Network [LDN] (4) there is a significant amount of data that each LDN (4) intelligent luminaire can generate. Each LDN (4) nodes data is added to the data generated in the ICS (2) nodes and the LCS (3) data sets it generates. Combined these data sets need to be managed for real time analytics in addition to being stored and forwarded to the appropriate nodes internal and external to the NLS (0). This Data & Streaming (14) software module in the LCS (3) manages the data sets and data streams so they will be preserved and communicated properly to other modules in the LCS (3) and other nodes internal and external to the NLS (0).

### Configuration Manager

The LCS (3) Configuration Manager (24) is the software module that will provide the ability for the LCS (3) to custom configure a NLS (0) for a specific building or complex. The LCS (3) Configuration manager will ingest as built architectural drawings and allows the physical layout of the NLS (0) to be defined. The LCS (3) Configuration Manager will assign specific ICS (2), LCS (3) and LDN (4) nodes in the NLS (0) system and communicate the details to the LCS (3) Operations Manager (23) through the Universal Data Base Manager (17).

### Operations Manager

The LCS (3) Operating Manager (23) is the software module that will communicate the operational information required to interpret ICS (2) instructions into actions defining LDN (4) operations. All operational data flow will be handled by the LCS (3) Operations Manager (23) software module. This includes interoperability with Building Intelligence Bus (75) modules and Stakeholder Intelligence Bus (74) modules. External data communications is addressed through the Request Brokers and APIs (76).

### Remote Access Manager

The LCS (3) will provide on and off site remote access. Specific users will have a multiplicity of needs that shall be addressed through the Remote Access Manager (22). Each type of user; programmer, system administrator, maintenance engineer, user and the like will need to be multi factor authenticated and authorized through the Security manager (13) to access the LCS (3). The Remote Access Manager (22) will deliver this remote access capability to the multiplicity of users. Remote Access Manager (22) will deliver health & status messages, alerts, emergency messages to registered, authenticated users based on the criteria defined in the Business Logic (15).

### Presentation Layer UI UX

The LCS (3) communication and message structure will be based on a Service Oriented Architecture [SOA] deployed as an n tier client/server computing model. This Domain Driven Design will include the business domains required to deliver the relevant information. This will be presented to the user in this presentation layer of the n tier client/server model. The presentation layer will include the User Interfaces [UI] for each of the modes of operation of the LCS (3). Together this will define the User eXperience [UX] in using the LCS (3).

### Intelligent Luminaires

Luminaries are lighting fixtures consisting of the light bulb and the stylized housing that holds the mechanical and optical elements. Luminaires are light fixtures as opposed to just a light bulb. Architects and designers select luminaires for specific usage throughout a facility. A typical office building may incorporate a suspended ceiling that may be outfitted with 2 ft.×4 ft. fluorescent troffer luminaries.

The Network Lighting System [NLS] (0) consists of Intelligent luminaries that comprise of a Luminaire Intelligence Module (35), a Solid State Light Engine (27) typically configured with Light Emitting Diodes [LED]s, a LED driver power supply (26) delivering the pulsed DC power at the correct voltage and current, optical wave guides reflectors diffusers and housing.

The particular solid state LED luminaries that are utilized in this invention are luminaires that are connected with Power over Ethernet [PoE] connections. The Network Lighting System [NLS] (0) is based on the power and Ethernet data communication provided on a PoE Network Lighting System [NLS] (0) as each luminaire would be connected to a powered data port on an Ethernet switch and external power supplies like AC mains for high power luminaires.

### Luminaire Device Network [LDN]

The Network Lighting System [NLS] (0) consists of intelligent Power over Ethernet [PoE] luminaries that incorporate the electrical power required to illuminate the LED light Engines (27) and include Ethernet data packet reception and transmission.

The invention augments PoE luminaries by adding a per luminaire device network LDN (4) that includes a multiport PoE Ethernet switch with PoE pass through (34), a microcontroller [MCU]/System on a chip [SoC] (35), DC to DC converters (28) and Pulse Width Modulation DC power supplies (26). By adding this combination of electronics to a PoE luminaire it facilitates the incorporation of the following optional LDN (4) Modules:

TABLE 1
LDN Module Options

| | |
|---|---|
| 1. | Vibration Sensors |
| 2. | Seismic P Wave Detectors |
| 3. | Earthquake Detectors |
| 4. | Sub Sonic Microphones |
| 5. | Sonic Microphones |
| 6. | Ultrasonic Microphones |
| 7. | Subsonic Transducers |
| 8. | Sonic Transducers |
| 9. | Ultrasonic Transducers |
| 10. | IR Cameras |
| 11. | Color Cameras |
| 12. | High Frame Rate HFR Cameras |
| 13. | High Dynamic Range HDR |
| | Cameras |
| 14. | UV Cameras |
| 15. | Multispectral Cameras |
| 16. | Hyperspectral Cameras |
| 17. | Colorimeter |
| 18. | Photoelasticity Imagers |
| 19. | Spectrophotometers |
| 20. | TOF Time Of Flight Imagers |
| 21. | LIDARs Light Intensity Distance |
| | And Ranging |
| 22. | Microwave Position Sensors |
| 23. | Microwave Gesture Sensors |
| 24. | Microwave Radiometer (MWR) |
| 25. | Ultrasonic Gesture Sensors |
| 26. | Cell Phone Transceivers |
| 27. | Wi-Fi Transceivers |
| 28. | Bluetooth Transceivers |
| 29. | GPS Global Positioning System |
| | Transceivers |
| 30. | AM Amplitude Modulation |
| | Transceivers |
| 31. | FM Frequency Modulation |
| | Transceivers |
| 32. | LF Low Frequency Transceivers |
| 33. | VHF Very High Frequency |
| | Transceivers |
| 34. | UHF Ultra High Frequency |
| | Transceivers |
| 35. | Microwave Transceivers |
| 36. | Fractal Antennas |
| 37. | Pixel Addressable Antennas |
| 38. | Reconfigurable Antennas |
| 39. | UWB Ultra-Wide Band |
| | Transceivers |
| 40. | UWB Position Measurement |
| | Systems |
| 41. | Lightning Detectors |
| 42. | Voltage Sensors |
| 43. | Current Sensors |
| 44. | Magnetic Sensors |
| 45. | EMI Electro Magnetic Interference |
| | Detectors |
| 46. | RFI Radio Frequency Interference |
| | Detectors |
| 47. | Free Space Optics |
| 48. | Li-Fi Transceivers |
| 49. | LED Light Engines |
| 50. | Color Temp Controlled LED Light |
| | Engines |
| 51. | UV Ultraviolet LED Light Engines |
| 52. | RGB Red Green Blue LED Light |
| | Engines |
| 53. | Color Specific LED Light Engines |
| 54. | IR Infrared LED Light Engines |
| 55. | Laser Light Engines |
| 56. | Photodetectors |
| 57. | Actinometers |
| 58. | ESD Protection |
| 59. | Electrical Energy Harvesters |
| 60. | Alarm Sensors |
| 61. | Motion Detectors |
| 62. | Glass Break Detectors |
| 63. | Shock Detectors |
| 64. | Occupancy Sensors |
| 65. | Proximity Sensors |
| 66. | Altimeters |
| 67. | Barometric Pressure Sensors |
| 68. | Gravimeter |
| 69. | Attitude Indicators |
| 70. | Flux Gate Compasses |
| 71. | Accelerometers |
| 72. | Inertial Sensors |
| 73. | Inertial Reference Unit |
| 74. | Level Sensor |
| 75. | MEMS Gyroscopes |
| 76. | Touch Sensors |
| 77. | RFID Tags |
| 78. | RFID Tag Readers |
| 79. | Flame Detectors |
| 80. | Smoke Detectors |
| 81. | Fire Detectors |
| 82. | Carbon Monoxide Detectors |
| 83. | Radon Detectors |
| 84. | Ionizing Radiation Detectors |
| 85. | Radiation Detectors |
| 86. | Neutron Detectors |
| 87. | Ion Detectors |
| 88. | Pellistor Sensors |
| 89. | Electronic Noses |
| 90. | Olfactometer Sensor |
| 91. | pH Sensors |
| 92. | Light Addressable Potentiometric |
| | Sensor (LAPS) |
| 93. | Photoionization Detector PID |
| 94. | Air Pollution Sensors |
| 95. | Chemical Sensors |
| 96. | Optrode Sensors |
| 97. | Hydrogen Sensor |
| 98. | Hydrogen Sulfide Sensor |
| 99. | Sulfur Dioxide Sensors |
| 100. | Nitrous Oxide Sensors |
| 101. | Nitrogen Sensor |
| 102. | Nitrogen Oxide Sensor |
| 103. | Oxygen Sensors |
| 104. | Ozone Sensors |
| 105. | Methane Sensors |
| 106. | Carbon Dioxide Sensors |
| 107. | Zinc Oxide Sensors |
| 108. | VOC Sensors |
| 109. | Biological Sensors |
| 110. | Pathogen Sensors |
| 111. | Fungi Sensors |
| 112. | Pollen Sensors |
| 113. | Asbestos Sensors |
| 114. | Fiberglass Sensors |
| 115. | Temperature Sensors |
| 116. | Humidity Sensors |
| 117. | Moisture Sensors |
| 118. | Dew Point Sensors |
| 119. | Water Sensors |
| 120. | Depth Gauge |
| 121. | Air Flow Sensors |
| 122. | Mass Air Flow sensor |
| | (MAF) |
| 123. | Air Velocity Sensors |
| 124. | Air Pressure Sensors |
| 125. | Airborne Particle Detectors |
| 126. | Metal Detectors |
| 127. | Strain Gages |
| 128. | Electrostatic Generators |
| 129. | Electrostatic Air Cleaners |
| 130. | UV Sterilizers |
| 131. | Oxygen Generators |
| 132. | Negative Ion Generators |
| 133. | Scenting Systems |
| 134. | Fragrance Dispensers |

The Luminaire Device Network [LDN] (4) extends the basic function of a PoE luminaire by adding the computing storage and networking circuitry required to make an intelligent luminaire. The optional LDN (4) modules defined in Table 1 allows the customization of each LDN (4) to define a building's NLS (0). The luminaires defined in this invention feature a custom configurable luminaire that has the LDN modules required to address system specific implementations requiring a multiplicity of LDNs (4).

### LDN Compute Storage & Networking

The NLS (0) LDN (4) requires each luminaire to be intelligent. The LDN (4) intelligence will require a Microcontroller [MCU] (35) to deliver the Computing, Digital Signal Processing [DSP], Networking, Inputs and Outputs [I/O], Clocks & Calendars, Cryptography, and Data Storage required. Data storage includes program memory, FLASH storage/SDCARD storage USB Storage. This integrated system will define the Internet Protocol [IP] address on the network that corresponds to each specific instance of an intelligent LDN (4) luminaire.

The Microcontroller [MCU] (35) will have a software framework that defines and supplies the following:
Hardware Adaption Layer/Board Configuration
Internal Peripherals Drivers: Ethernet, PWM, UART, I/O, USB, SPI, I2C, DAC, ADC, Timer
External Peripherals Drivers: Sensors, DataFlash, Compass, LCD, LED, NTC, LDR, Contact Closure
Communications Stack Services and Libraries: TCP/IP, Math Library, Graphics Library, USB HID, SDCARD, AES, MP3, FAT32
Application Layer:
LDN (4) Applications
PWM Resonance Optimizer
PWM Dimming Control
Data Acquisition
Data Streaming
Sensor Data Preprocessing
Other Applications on LDN (4)

### LDN Addressability

The LDN (4) Luminaire preferred embodiment would use Internet Protocol [IP] version 6 [IPv6] RFC 2460 Open Systems Interconnection [OSI] layer 2 Data Link and layer 3 Network to uniquely identify a Luminaire and LDN (4) modules instantiated on a specific luminaire in a network lighting system NLS (0). Multiple layer 2 MAC address and or Layer 3 Internet Protocol [IP] addresses may exist on a specifically configured. This computer network addressability will be used to create a LDN Configuration Management System (24) that will uniquely identify a specific intelligent luminaire and its specific complement of LDN (4) modules.

### LDN Data Acquisition

The invention creates multiplicity of data sets from imagers, sensors, detectors, transceivers, tags and transducers. The LDN (4) creates an individually addressable intelligent Luminaire. The LDN Manufacturing Configuration Management System will include intelligent luminaire specific configuration data on the set of modules configured. This unique identifier will be manifested in a multiplicity of ways a physical label/Code, a RFID tag or related method and the L2 MAC and or L3 IP addresses. Additional identification and addressing may include other modules on the LDN intelligent luminaire. This real time audit trail access delivers LDN Module specific parameters and values, calibration information, performance history, health and status monitoring.

The complement of these modules will generate a multiplicity of data types and different intervals. These data sets will be acquired through the NLS (0) Lighting Control System [LCS] (3). The LCS (3) will manage the LDN (4) Module data traffic to the Network Lighting Systems [NLS] (0) Data Acquisition Systems. The Network Lighting Systems [NLS] (0) Data Acquisition Systems will provide the first level of LDN (4) Module data management. At the Network Lighting Systems [NLS] (0) Data Acquisition System level we will refer to this as RAW sensor data even though the Microcontroller Unit MCU (35) may have performed some RAW data processing.

LDN Pulse Width Modulation Optimization

### PWM Pulse Trains Wave Forms

The invention includes processes to identify the quasi resonance of the Light Engines (27). Resonance occurs in a LC circuit when the PWM frequency at which the inductive and capacitive reactances are equal in magnitude. The frequency at which this equality holds for the particular circuit is called the resonant frequency. The equivalent circuit of the light engine has inductance L and capacitance C values that create a tank circuit. Each tank circuit has a resonance which reduces the amount of energy required to drive the circuit.

The LDN (4) microcontroller [MCU] (35) has programmable PWM capabilities integrated into the MCU (35). The MCU (35) PWM capability provides for multi-channel high and low outputs complemented by fault and external trigger inputs. The MCU (35) has the inputs and outputs I/O to construct a digital multimeter that allows the MCU (35) to measure current and voltages on the Light Engines (27) that will be driven by the PWM circuits.

Configuring a MCU (35) to measure the electrical currents and voltages that the Light Engines (27) or exposed to is complemented by a image sensor connected to the MCU (35) I/O to measure the radiant flux or brightness and or color temperature radiated by the Light Engines (27). This closed loop allows the MCU (35) to be programmed to setup and execute a program that will identify several optimal PWM configurations related to maximum brightness, efficiency, and desired color temperature.

The LDN (4) PWM modules (26) under control of the MCU (35) programmable PWM controller will increment and decrement internal timers and counters as required to generate a multiplicity of PWM pulse trains. This allows a parametric sweep of pulse trains to identify the combinations that create the right balance of radiant luminosity, color temperature, and power consumption. The PWM modules can be programmed to identify the optimal DC power waveforms and drive the Light Engines (27) by measuring the power consumption that can be calculated by the MCU (35) multimeter readings.

### Multi Pulse Width Modulation

The invention includes a technique to drive the LDN (4) PWM modules (26) with very high frequencies. The DC power waveforms that have been derived from the Light Engines (27) LDN Pulse Width Modulation Optimization process can be further sliced in shorter time domain wave forms that permit free space optical data transmission.

Data from the NWS (1) can be directed to a very high frequency PWM (26) module. The PWM module (2) has the capability to encode data packets into the long period of the Pulse Width Modulation Optimization method described in this disclosure. Within the Pulse Width Modulation Optimized pulse train we are able to encode higher frequency shorter period pulse trains. This short period high frequency pulse trains can be switched on and off up to the limits of light engine (27) performance

Optimized PWM Light Engine Driver with Data Encoding

Now the light engine (27) is switched on and off at very high blink rate that is unperceivable by humans. With the light engine blinking at a very high rate the light emitted by the light engine (27) is capable to transmitting data through free space optics to a properly configured optical receiver.

The optical receiver would be able to recreate the electrical data packets that were encoded into the electrical pulse train created by the PWM (26) module or modules that was converted to optical waveform energy by the light engines (27). The data packets could be delivered to a plurality or single intelligent luminaire in a NLS (0).

### NLS LDN Data Processing

NLS (0) LDN (4) data sources can be processed in the LCS (3) to turn data into knowledge. A multiplicity of data processing types can be used to increase the relevance and usability of LDN (4) Module data. The Building's Intelligence System (39) may need to know who is in the building. By adding facial recognition processing to NLS Data Sets (57) the image data can be correlated with the Building Stakeholder Profiles (62) to confirm each known person in the building. This allows a constantly evolving Building Stakeholder Profiles (62) contents by adding visitors and others that are just entering the system by visiting the building.

Many other types of data processing will be employed to make the LDN (4) and BAS (53) data sets useful in decision making. Many multifactor data correlations performed at this level will have significant relevance in higher level decision support or decision rendering.

If an employee of 10 years is trying to gain access to an entrance that they never use and the access control system is giving the clearance to open the door because the access card matches a valid card the Building Intelligence System (39) can inhibit access because it does not match the Building's Stakeholders Behavior Systems (64) information and the cameras facial recognition does not match.

### Relevance Based Digital Building Information Architecture

The Relevance Based Digital Building Information Architecture (FIG. 5.) leverages the NLS (0) network to deliver relevance based interoperability between building systems to combine real time analytics and control to deliver building digital intelligence. In parallel the Relevance Based Digital Building Information Architecture (FIG. 5.) delivers relevance based interoperability between the buildings stakeholders and between the stakeholders and the intelligent building. This is defined as:

### 75 Building's Information Architecture

### 74 Stakeholders Information Architecture

The Relevance Based Digital Building Information Architecture (FIG. 5.) is a combination of the NLS (0) with the disclosed information architecture that creates the semantics required to manage a controlled vocabulary for industry specific usage. This application of semantic microdata improves the metadata quality of the data essences generated by the buildings systems and external unstructured data sources. The Relevance Based Digital Building Information Architecture (FIG. 5.) for the NLS (0) will generate massive amounts of image and telemetry data from the modules that comprise the LDN (4) on each luminaire. Add thousands and millions of LDN (4) configured luminaires and you have a Big Data Set (38).

Now combine the multiplicity of stakeholders associated with and building and you have interrelated groups and individuals that own, manage, operate and visit and given facility for a plurality of reasons. Each stakeholder requires specific information and interoperability with any given facility over the course of time. The Relevance Based Digital Building Information Architecture (FIG. 5.) adds a semantic controlled vocabulary to each individual stakeholder allowing high relevance interoperability between stake holders and then delivers high relevance cased interoperability with the building. To accomplish this RBDB has invented the following information architecture.

### RBDB Building's Information Architecture

### 49 Natural Language Lexicons

A lexicon is the vocabulary of a person, language, or discipline of knowledge (such as Real Estate or Medical). As each natural language evolves and addition words and meanings are added a set of agreed upon lexical usage is defined concurrent with area of interest domains that may offer additional words, meanings such as Slang terms, Jargon for an area of interest and colloquialisms. Each definition of a specific word can be identified as there may be multiple meaning for any given work.

The Relevance Based Digital Building Information Architecture (FIG. 5.) incorporates large lexical databases of natural languages (49). Nouns, verbs, adjectives and adverbs are defined and also grouped into sets of cognitive synonyms (synsets), each expressing a distinct concept. Synsets are interlinked by means of conceptual-semantic and lexical relations.

### 48 Building's Systems Ontology

Ontology is a formal naming and definition of the types, properties, and interrelationships of the entities that exist for a particular domain or area of study. Ontology compartmentalizes the variables needed for some set of computations and establishes the relationships between them.

The fields of artificial intelligence, the Semantic Web, systems engineering, software engineering, biomedical informatics, library science, enterprise bookmarking, and information architecture all create ontologies (48) to limit complexity and to organize information. The ontology can then be applied to problem solving.

The Relevance Based Digital Building Information Architecture (FIG. 5.) imports and extends Ontologies to structure the data for high relevance use.

### 47 Data Metadata & Microdata

The data generated by the NLS (0) and related building systems may consist of a parameter and a value e.g. temperature 70° F. This data is referred to as the raw essence data as it requires additional data to make it useful.

Data that is used to describe essence data is referred to as metadata, this is data about data. Two types of metadata exist: structural metadata and descriptive metadata. Structural metadata is data about the containers of data. Descriptive metadata uses individual instances of application data or the data content.

The invention utilizes another type of metadata called microdata (47). Microdata (47) allow semantic tagging of data to reveal content and usage.

### 56 NLS LDN Data Sets & Controls

The building incorporation of the NLS (0) into the structure provides a set of controls (56) to configure and operate and adapt the NLS (0) components to stakeholders preferences. Specifically a network of luminaires with LDN (4) modules provides the ability to set the operational parameters of each individual component and LDN (4) module.

Each intelligent luminaire in the NLS (0) system may be configured with a multiplicity of LDN (4) modules that are capable of generating data. The data exchange with NLS (0) LDNs (4) may include real time, streaming and recorded data.

Each LDN (4) has a set of parameters and settings that will define each LDN (4) modules operational controls. LDN (4) controls allow the PWM module to control its pulse train to dim the light, change the color temperature. Other controls may change the operational parameters and corresponding values for a camera or other LDN (4) modules. The controls provide the real time adaptions for stakeholder's or building's use.

### 53 Building's Systems Data Sets & Controls

Additional systems in the building may be under automation control or can be adapted for operation based on stake holder's preferences. The NLS (0) is just one of many systems that may be under the control of a Building Automation System (53).

Each Building Automation System [BAS] (53) may be configured with a multiplicity of modules that are capable of generating data. The data exchange with BAS (53) may include real time, streaming and recorded data.
Building Automation Systems (53) may include:

| | |
|---|---|
| Access Control Systems | Video Surveillance Systems |
| HVAC Control Systems | Elevator Control Systems |
| Fire Control Systems | Communications Systems |
| Boiler Control Systems | Audio Video Control Systems |
| Lighting Control Systems | Waste Management Systems |
| Energy Monitoring Systems | Earthquake Detection Systems |
| Emergency Power Systems | Laboratory Automation Systems |
| Alarm Control Systems | Factory Automation Systems |
| Security Systems | Information Technology Systems |

### 50 External Data Sets & Back Channels

Many factors defining the building's operation may be affected by external information from government, public and private sources. These data sources and back channels are incorporated into the information architecture to insure the relevance of the direct or derived information. This information will be processed as data acquisition feeds in real time, streams and as recorded data.

### 46 Building's Data Repository

The data sources will present unstructured data and structured data to be managed. Some of the unstructured data will remain unstructured however most will be structured through the metadata and microdata associations to the essence data. Once these tasks are complete the data must be steamed, stored and forwarded to other systems in the information architecture from the building's data repository.

The building's data repository is configured to accept traditional entity relationships as they may exist in object relational databases, additionally the semantics introduced by the invention may also require the use of Resource Description Framework [RDF] triple stores and key value data persistence.

### 45 Buildings Digital Profiles

The building has a multiplicity of systems, operations and interrelationships that need to be captured and defined in a way that the Building Intelligence Systems (39) can determine what the best practices may be for any situation.

### 44 Building Systems Semantic Reasoner

Semantic Reasoners/Inference Engines have the ability to infer what a user may want next by the usage paradigm of structured data and classifications. The reasoner can adjust the relevance by using the lexical definitions in the Lexicon (4) that feeds an ontology (48), which is managed in a repository (46).

The reasoners can deliver Predictive Business Logic to a multiplicity of users interfacing with the Buildings Intelligence (39) systems.

### 43 Building Governance

A building governance module is a Rules Engine that manages Legal, Operational policies and producers on the Building's Software Bus (75) these legal and business rules can be used to define a subset of criteria that enables machine to machine [M2M] transactions. A Building's BOT (37) can be sent out on the internet to find several qualified sources to supply the antibacterial soap used in the washrooms. Because the BOT was informed of the micro transaction laws and agreements it is able to conduct transaction with vendors like a purchasing agent would do without human intervention.

### 42 Real Estate Management Systems

One or more Real Estate Management systems may be connected to the Building's Software Bus (75) Beyond Real Estate Management systems Property & Facilities Management, Operations & Accounting features Integrated Workplace Management Systems [IWMS] may be integrated into the software modules. These advancements contribute to the ability to create a Building's Intelligence System (39) that can provide best practices intra and inter facilities.

### 41 Building Analytics Systems

Building Analytics Systems (41) will provide the ability to apply a multiplicity of Analytics Engines to the data sets represented in the External Data Sets & Back Channels (50), Building Automation Systems [BAS] Data Sets and Controls (53) and the Network Lighting System [NLS] Data Sets & Controls (56) in order to analyze the data.

Building Analytic Systems (41) focuses on modeling and knowledge discovery that covers: data mining, data description, exploratory data analysis [EDA], confirmatory data analysis [CDA], aggregation, business intelligence, predictive analytics, predictive business logic and related techniques.

### 40 Building's Visualization Systems

Building's Visualization Systems (40) process data from External Data Sets & Back Channels (50), Building Automation Systems [BAS] Data Sets and Controls (53) and the Network Lighting System [NLS] Data Sets & Controls (56) in order to visualize the data. Some data is organized in tables that can be visualized for greater comprehension and interaction. Visualization techniques cover a multiplicity of techniques that range from creating a simple graph to a 3D immersive world. Interaction with visual data can greatly improve the User eXperience [UX] when operating with physical or abstract data sets.

### 39 Building's Digital Intelligence Systems

Building's Digital Intelligence Systems (39) are created out of real time responsiveness to a multiplicity of software modules on the Buildings Software Bus (75). Command Control Communications Intelligence [C3I] is provided from the Building's Digital Intelligence Systems (39). These systems has deep learning and cognitive abilities resulting from the ability to observe all information available and continually processing this information to learn the best practices in conjunction with the goals the system operators instruct the Digital Intelligence Systems (39) to seek.

### 38 Building's Big Data Systems

The tracking, curation, and analysis of the Building's Big Data will be handled in the Building's Big Data Systems (38). The Building's Big Data Systems (38) will have structured data that has been structured through the Natural Language Lexicon (49) definitions, the Building's Systems Ontology (48), the Building's Semantic Micro Data (47) tagging and associated metadata. The Building's Big Data Systems (38) are structured to accommodate the volume and turnover of the big data sets generated by the Network Lighting System [NLS] Data Sets Repositories (58), Building Automation Systems [BAS] Data Sets Repositories (55), External Data Sets Repositories (52) and related data sets as required that are interconnected on the Buildings Software Bus (75).

### 37 Building's Bots Automated Systems

Building's Bots Automated Systems (37) deploys Automated Digital Task Robots as software modules that can research, communicate, transact and advise Machine to Machine [M2M] business and machine to human business. Bots can address building's health, Status, State, Activity, Responses, Procurement, Emergencies, Standards and Objectives.

### 76 Request Brokers & Application Programming Interfaces

The Relevance Based Digital Building Information Architecture (FIG. 5.) makes use of request brokers and Application Programming Interfaces (76) and related techniques to properly interoperate with other software modules on the Stakeholders Software Bus (74), Buildings Software Bus (75), External Data Sets & Back Channels (50) and other external systems that may be required.

### 74 Stakeholders Information Architecture

### 59 Natural Language Lexicons

A lexicon is the vocabulary of a person, language, or discipline of knowledge (such as Real Estate or Medical). As each natural language evolves and addition words and meanings are added a set of agreed upon lexical usage is defined concurrent with area of interest domains that may offer additional words, meanings such as Slang terms, Jargon for an area of interest and colloquialisms. Each definition of a specific word can be identified as there may be multiple meaning for any given work.

The Relevance Based Digital Building Information Architecture (FIG. 5.) incorporates large lexical databases of natural languages. Nouns, verbs, adjectives and adverbs are defined and also grouped into sets of cognitive synonyms (Synsets), each expressing a distinct concept. Synsets are interlinked by means of conceptual-semantic and lexical relations.

### 60 Building Use and Stakeholder's Ontology

An ontology is a formal naming and definition of the types, properties, and interrelationships of the entities that exist for a particular domain or area of study. Ontology compartmentalizes the variables needed for some set of computations and establishes the relationships between them.

The stakeholders may exhibit a plurality of roles that are defined as digital personas. These digital personas are defined in the ontologies schema of a thing called a person. The RBDB invention defines multiple modes of any individual as they may change their digital persona when interacting with other stakeholders and the building. For example a person may be the building owner a medical doctor working in the building and a patient of another medical doctor all in the same day. The individuals digital persona needs to be presented to the stake holders and the building based on which role they are in at a particular time.

The Relevance Based Digital Building Information Architecture (FIG. 5.) imports and extends Ontologies to structure the data for high relevance use.

### 61 Building's Use and Stakeholders Semantics

The data generated by the stakeholders may consist of a parameter and a value e.g. profession Medical Doctor MD. This data is referred to as the raw essence data as it requires additional data to make it useful. Building's Use and Stakeholders Semantics (61) data that is used to describe essence data is referred to as metadata, this is data about data. Two types of metadata exist: structural metadata and descriptive metadata. Structural metadata is data about the containers of data. Descriptive metadata uses individual instances of application data or the data content.

The invention utilizes another type of metadata called microdata in Building's Use and Stakeholders Semantics (61). Microdata allow semantic tagging of data to reveal content and usage.

### 62 Building Stakeholders Profiles

The RBDB invention defines a software module that manages secure stakeholder profiles (62). The Building Stakeholders Profiles (62) provides the ability to define a profile for each individual. Profile information pertains to the person's identity, education, experiences, capabilities, preferences and related information that may be available or required to define Digital Personas.

### 63 Building Use & Stakeholders Governance

Building's Use & Stakeholders Governance Systems (63) provide digital information related to local, state and federal, legal and regulatory framework for the use of the building by its stakeholders. Stakeholders represented as owners, partners, stock holders, board of directors', executives and staff are all governed and abide by the bylaws, operating agreements and employee agreements. These policies and procedures and accounting practices must be communicated in a structured digital format to support Building's Analytics Systems (41), Building's Bots (37), and Building's Digital Intelligence Systems (39). The Building's Use & Stakeholders Governance Systems (63) is a type of rules engine managing a complex interaction of rights, permissions, privileges and related topics that is referenced by the Stakeholders Digital Intelligence Systems (72) and other software modules on the Stakeholders Software Bus (74).

### 64 Building Stakeholder Behavior Systems

The Building Stakeholder Behavior Systems (64) capture the patterns of behavior each person demonstrates during the course of their interaction with the other stakeholders in the building. These idiosyncratic patterns are captured over time to identify normal behavior patterns and abnormal behavior patterns. The Building Stakeholder Behavior Systems (64) models normal stakeholder behavior patterns and alerts the Stakeholders Digital Intelligence Systems (72) to decide if and when any action is warranted.

### 65 Stakeholders Semantic Repository

Stakeholders Semantic Repository Manager (65) will coordinate the management of data from a multiplicity of data repositories. This includes data management with Building's Use and Stakeholders Semantics (61), Building's Stakeholders Profiles (62), providing a universal database interface to the Stakeholders software buss (74) for all software modules to access when needed.

### 66 Building Stakeholders Semantic Reasoner

Building's Stakeholders Semantic Reasoner (66) is a semantic inference engine that provides digital intelligence by inferring what the agent and environment interaction is at any given state. The Building's Stakeholders Semantic Reasoner (66), reasoning engine, rules engine, or simply a reasoner, is software that infers logical consequences from a set of asserted facts or axioms driven from the multiplicity of software modules interoperating on the Stakeholders Software Bus (74). Stakeholders may use the Building's Stakeholders Semantic Reasoner (66) as predictive business logic to present potential outcome in what if scenarios.

### 67 Building Stakeholders Monitoring

The Building's Stakeholders Monitoring Systems (67) is the software module that analyzes the Building Stakeholder Behavior Systems (64), Building's Stakeholders Digital Profiles (62) and any other software system on the Stakeholders Software Bus (74) that is required to identify abnormal behavior patterns in the building's stakeholders.

### 68 Building Stakeholders Personalization

Building Stakeholders Personalization (68) manages a multiplicity of preferences, working modalities that can be based on an Individual Department, Group or set of individuals to cause the building's systems to adapt. Building Stakeholders Personalization (68) communicates Building Adaptation Requests to the Network Lighting System [NLS] Data Sets & Controls (56), Building Automation Systems [BAS] Data Sets and Controls (53), and External Data Sets & Back Channels (50) to modify the current buildings operational status.

Building Stakeholders Personalization (68) may send a request to adjust light levels, change the temperature, mute the background audio based on an individual's preferences in occupying their office. All possible combinations that are within the acceptable Building's Governance Systems (43) can be adapted in real time or as near real time as practical.

### 69 Stakeholder Visualization Systems

Stakeholder Visualization Systems (69) process data from any of the software system on the Stakeholders Software Bus (74) in order to visualize the data. Some data is organized in tables that can be visualized for greater comprehension and interaction. Visualization techniques cover a multiplicity of techniques that range from creating a simple graph to a 3D immersive world. Interaction with visual data can greatly improve the User eXperience [UX] when operating with physical or abstract data sets. Visualizations may create interactive interfaces that allow intuitive control of the stakeholder's information systems.

### 70 Stakeholders Big Data Systems

The tracking, curation, and analysis of the stakeholder big data Systems will be handled in the Stakeholder Big Data Systems (70) The Stakeholder Big Data Systems (70) will have structured data that has been structured through the Natural Language Lexicon (59) definitions, the Building's Use and Stakeholders Ontology (60) the Building's Use and Stakeholders Semantics (61) tagging and associated metadata. The Stakeholder Big Data Systems (70) are structured to accommodate the volume and turnover of the big data sets generated by the Building's Stakeholders Profiles (62), Building's Stakeholders Behavior Systems (64), and related data sets as required that are interconnected on the Stakeholders Software Bus (74).

### 71 Building Use Industry Specific Systems

Building Use Industry Specific Systems (71) manages industry specific data sets that are not represented in the Stakeholders Governance Systems (63) as many industry specifics are stakeholder relevant. The Building Use Industry Specific Systems (71) would manage the requirements of operating any specific industry whereas the stakeholders are responsible for proper operation and handling of equipment and materials. For example specific industries use specialized materials. OSHA requires each material to have a Material Safety Data Sheets [MSDS] to define the correct handling and emergency procedures. The Building Use Industry Specific Systems (71) would manage these types of information systems. The Building Use Industry Specific Systems (71) would be loaded with the relevant and required data for each industry sector that is or has occupied space in the building.

Building Use Industry Specific Systems (71) delivers stakeholder relevant information required performing client/customer interactions with other stakeholders. This will improve the relevance of information and thus improve client/customer experience and satisfaction.

### 72 Stakeholder Digital Intelligence Systems

Stakeholders Digital Intelligence Systems (72) leverage the complete semantics and analytics in real time to deliver Command Control Communications Intelligence about the buildings stakeholders and their interactions. Stakeholders Digital Intelligence Systems (72) combines a multiplicity of Artificial Intelligence [AI] techniques. The AI techniques include;

| | |
|---|---|
| Epistemology | Planning |
| Ontology | Goal Seeking |
| Heuristics | Learning from Experience |
| Logical Analysis | Look Ahead |
| Statistical Probabilities | Genetic Computing |
| Inference | Recognition of Patterns |

### 73 Stakeholder Bots Automated Systems

M2M [Machine to Machine] communications and transactions may be initiated and managed by Stakeholder Bots Automated Systems (73). Stakeholder transaction, automated searches and related activities may utilize a software Bot as an automated process to perform these activities. Stakeholder Bots Automated Systems (73) are automated digital task bots that are launched manually or automatically to traverse the Relevance Based Digital Building Information Architecture (FIG. 5.) and external public and private networks to perform their tasks.

### Interoperability Between Building and Stake Holders

The Relevance Based Digital Building Information Architecture (FIG. 5.) has created an advanced level of relevance based intelligence that allows the Building to become an artificial intelligence. If we use the Burj Khalifa building in Dubai United Arab Emirates as an example the buildings identity is Burj Khalifa.

### Digital Building Self Awareness

The Relevance Based Digital Building Information Architecture (FIG. 5.) allows the Burj Khalifa to be self-aware at an AI level. The Burj Khalifa would know where it is in the world, who designed her, who built her, who owns her and what activities take place at the Burj Khalifa. The Building's Digital Intelligence Systems (39) that have been data populated and trained for the Burj Khalifa.

This process allows the building to know why she was built, what prestige she has and everything related to her design construction, furniture, fixtures and equipment [FFE]. Now every of the Burj Khalifa's systems details are available to the authorized stakeholders allowing them to manage and predict issues and remedies related to the buildings structure and infrastructure. The Burj Khalifa knows the contractor, manufacturer, model number serial number and performance of every system in her. The Burj Khalifa can use the Building's Digital Intelligence Systems (39) to predict the Repair Maintenance and Overhaul [RMO] activities required to keep her healthy and fit for her job.

The Burj Khalifa has access to all of the Building Automation Systems that provides her situational awareness as to the activities and abnormalities that are present at any point in time. By being self-aware the Burj Khalifa can be instructed to protect herself from damage, intrusion, theft and related issues. Given these directives the Building's Governance Systems (43) are referenced to determine how to handle the multiplicity of situations. These autonomous logistics functions use multiple factors to provide access to stakeholders, monitor what they are carrying and what behaviors are permitted, flagged and thwarted.

### Digital Building Performance Monitoring

Some of the building's stakeholders are involved in the management and operation of the facility or complex of facilities. These stakeholders would have the rights and privileges to query the Building's Digital Intelligence Systems (39) to become informed how the building perceives its performance, health and status. A multiplicity of use cases are simultaneously processed that can range from how much energy is being used to how we can avoid physical and cyber-attacks. These stakeholders are empowered by the Building's Digital Intelligence Systems (39) to define what if scenarios and plan for unforeseen events. Now for the first time operational performance, disaster avoidance and disaster recovery can employ best practices from a proactive position.

### Profession Based Occupancy

The next level of capability focuses on Building's Stakeholders Personalization Systems (68) that provide the ability for the building to adapt to the preferences and requirements of its occupants. The RBDB invention provides a multiplicity of systems that enhance the interaction between the building and its stakeholders. These systems are: Building's Stakeholders Profiles (62), Stakeholders Governance Systems (63), Building's Stakeholders Behavior Systems (64), Building's Stakeholders Monitoring Systems (67), and Building's Stakeholders Personalization Systems (68). Together all requests to modify the building operational modes can be evaluated and processed in real time.

The Building's Stakeholders Profiles (62) define professions, roles, permissions and privileges that are communicated to the Building's Stakeholders Personalization Systems (68) as a request to modify one or more of the buildings operational parameters. Once the Building's Stakeholders Personalization Systems (68) has consulted with the relevant systems the request can be granted, additional information requested or denied.

Now the building can change a light level, route a Li-Fi session to a specific location, Adjust the temperature in a conference room, change the HVAC blower speed in an auditorium, and all other similar work function or personal preference adaptations required.

### Interoperability Between Stake Holders and Other Stake Holders

The RBDB provides advanced features for stakeholder to stakeholder interactions that can be augmented by the Stakeholders Digital Intelligence (72). Some stakeholders interactions may be between tenant and landlord, others may be between tenant businesses and their clients. This and many other interaction scenarios are enhanced by the Stakeholders Digital Intelligence (72) and its interaction with the Building's Digital Intelligence Systems (39). Each of these interactions has the ability to consult with the RBDB systems to have them add value when requested.

### Owners, Operators, Management

Stakeholders that represent building owners, building operators or building management each has a specific focus and objective. The RBDB invention provides real time responsive interactions as required for decision support. Owners may be evaluating the operators and managements performance to increase the value of their investment. These stakeholders may query the Building's Digital Intelligence Systems (39) to request an evaluation as to the fit and finish related to attracting as higher rate tenants. The Building's Digital Intelligence Systems (39) can send out Building's Bots (37) and determine the range of $/sq. ft. for many of the surrounding buildings. The owner was considering a significant renovation budget; however the results of the Building's Bots (37) research and the multifactor analysis of the Building's Digital Intelligence Systems (39) determined that most of the new tenants in the area are young entrepreneurs who would prefer a more modern loft type of space.

A concurrent discussion was initiated between the buildings management company and the owner that focused on the maintenance of the building, specifically the operation performance and efficiency of one of the HVAC systems. Management queried the Building Automation Systems [BAS] Data Sets Repositories (55) and learned that the HVAC in question was out of warranty, had been repaired twice and was determined to be underrated for its application by the Building's Analytics Systems (41). The Building's Bots (37) had already initiated an email request to the HVAC engineer to share their calculations and assumptions that were used in selecting this particular unit. The Building's Stakeholders Profiles (62) revealed that maintenance engineer for the building use to work for the HVAC company and is able to expedite the upgrade due to a personal contact with the company. Information is power, just in time information is even more powerful. The RBDB invention provides an unlimited number of applications and use cases related to integrating the Building's Digital Intelligence Systems (39) with the Stakeholders Digital Intelligence (72).

### Tenants, Business Operators, Employees, Clients

Visitors to the building can be registered automatically through the NLS (0) LDN (4) modules. LDN (4) camera modules can capture images and run them through facial recognition processing to see if this particular individual has visited before. Upon interchange with the Building's Stakeholders Profiles (62) it is determined that this particular individual is one of the Federal Express delivery men and directs him to the proper location in the building where the recipient is awaiting his delivery.

Clients and customers present additional Stakeholders Digital Intelligence (72) opportunities as the system can deliver just in time information to business owners and their employees to improve the customers' experience and satisfaction.

A patient arrives at a RBDB medical facility. The LDN (4) modules cameras and pico cell site configured on the NLS (0) are used as data sources for the Building's Stakeholders Profiles (62) which identifies the individual as a patient of Dr. Bishop and determines that they are here to have some tests performed. The Stakeholders Digital Intelligence (72) sends a SMS text message to the patient's phone directing them to the location in the building where the tests will be performed while it sends the data to the tenant's electronic patient record system informing them of the patient's arrival.

An unlimited number of examples and use cases can be generated using the integration of the RBDB Building's Digital Intelligence Systems (39) with the Stakeholders Digital Intelligence (72).

1. A method of enabling a relevance-based digital building system, the method comprising:
defining stakeholder operational criteria, wherein stakeholder rules, stakeholder rights, stakeholder privileges, stakeholder roles, and stakeholder profiles are programmed;
defining building system optimization criteria, wherein building system rules, building system definitions, and building system data dictionaries are programmed;
querying the digital building system to determine building system self-awareness and building system optimization based on building system optimization criteria;
verifying that the digital building system is optimized, wherein said optimization is done by the building system; and
examining stakeholder operational criteria, said operational criteria used to train artificial intelligence (AI) and deep learning in order to utilize a plurality of building system BOTS.

2. A method as recited in claim 1 wherein if the digital building system is not optimized, said building system determines what actions to take to optimize the digital building system.

3. A method as recited in claim 1 further comprising:
determining if the digital building system is operating within previously defined building standards.

4. A method as recited in claim 1 further comprising:
determining whether abnormal operations or activities are occurring in the digital building system and initiating actions to ensure that the building system operates within normal operation.

5. A method as recited in claim 4 further comprising logging and verifying parameters of normal operation of the digital building system.

6. A method as recited in claim 1 further comprising: determining whether there is a threat to a stakeholder and building contents and whether to invoke emergency procedures.

7. A method as recited in claim 1 further comprising:
determining whether repair, overhaul, or maintenance of digital building system is needed.

8. A method as recited in claim 1 further comprising:
determining whether stakeholder interoperability is modified or whether stakeholder-building interoperability is modified; and
determining whether corrective action should be taken.

9. A method as recited in claim 1 further comprising:
importing a digital building system ontology and stakeholder ontology thereby enabling high-relevance use in a building having the digital building system.

10. A method as recited in claim 9 further comprising:
altering a stakeholder digital profile based on a stakeholder role in the building.

11. A method as recited in claim 1 further comprising:
optimizing self-awareness and AI-driven operations of the digital building system, thereby enabling relevance-based interoperability between the digital building system and stakeholder.
